(19) United States
(12) Patent Application Publication
(10) Pub. No.: US 2025/0076472 A1
(43) Pub. Date: Mar. 6, 2025

(54) APPARATUS, SYSTEM, AND MOVING BODY

(71) Applicant: CANON KABUSHIKI KAISHA, Tokyo (JP)

(72) Inventors: Kenzo TOJIMA, Tokyo (JP); Kazuhiro MORIMOTO, Kanagawa (JP); Naoki ISODA, Tokyo (JP); Yu MAEHASHI, Hokkaido (JP)

(21) Appl. No.: 18/816,437

(22) Filed: Aug. 27, 2024

(30) Foreign Application Priority Data
Aug. 30, 2023 (JP) 2023-139546

(51) Int. Cl. G01S 7/4861; G01J 1/42; G01J 1/44

(52) U.S. Cl. CPC G01S 7/4861; G01J 1/4228; G01J 1/44; G01J 2001/4466

(57) ABSTRACT

An apparatus includes a pixel array in which a plurality of pixels including a photoelectric conversion element is arranged, a first readout unit for acquiring a first micro-frame, a second readout unit for acquiring a second micro-frame, a first addition unit for generating a first sub-frame by synthesizing the first micro-frame, and a second addition unit for generating a second sub-frame by synthesizing the second micro-frame, in which a first exposure period in which generation of a signal included in the first micro-frame is performed is controlled in accordance with a first control signal, a second exposure period in which generation of a signal included in the second micro-frame is performed is controlled in accordance with a second control signal, and in an acquisition period of one micro-frame, the first exposure period and the second exposure period differ from each other.

### BACKGROUND

### Technical Field

The aspect of the embodiments relates to a photoelectric conversion apparatus and a photoelectric conversion system including the photoelectric conversion apparatus.

### Description of the Related Art

United States Patent Application Publication No. 2017/0052065 discusses a distance measurement apparatus that measures a distance to an object by emitting light from a light source and receiving light including reflected light from the object with a light receiving element. United States Patent Application Publication No. 2017/0052065 discusses a method of repeatedly performing measurement while varying a gating period in which the detection of photons is performed in a single photon avalanche diode (SPAD) element.

In the method (Time-gate method) discussed in United States Patent Application Publication No. 2017/0052065, a tradeoff relationship exists between a distance resolution and a frame rate.

### SUMMARY

According to an aspect of the embodiments, an apparatus includes a pixel array in which a plurality of pixels including a photoelectric conversion element is arranged in an array, a first readout unit configured to acquire a first micro-frame based on incident light on each of the plurality of pixels, a second readout unit configured to acquire a second micro-frame based on incident light on each of the plurality of pixels, a first addition unit configured to generate a first sub-frame by synthesizing the first micro-frame, a second addition unit configured to generate a second sub-frame by synthesizing the second micro-frame. A first exposure period in which generation of a signal included in the first micro-frame is performed is controlled in accordance with a first control signal. A second exposure period in which generation of a signal included in the second micro-frame is performed is controlled in accordance with a second control signal. In an acquisition period of one micro-frame, the first exposure period and the second exposure period differ from each other.

According to another aspect of the embodiments, an apparatus includes a pixel array in which a plurality of pixels including a photodiode is arranged in an array, an input terminal of a first gating circuit to which a signal included in a first micro-frame is input, and an input terminal of a second gating circuit to which a signal included in a second micro-frame is input, which are connected in parallel to an output terminal of the photodiode, a first readout unit configured to acquire the first micro-frame that is connected to an output terminal of the first gating circuit via a first counter circuit configured to count a signal included in the first micro-frame, a second readout unit configured to acquire the second micro-frame that is connected to an output terminal of the second gating circuit via a second counter circuit configured to count a signal included in the second micro-frame, a first addition unit configured to generate a first sub-frame by synthesizing the first micro-frame, and a second addition unit configured to generate a second sub-frame by synthesizing the second micro-frame.

Further features of the disclosure will become apparent from the following description of exemplary embodiments with reference to the attached drawings.

### BRIEF DESCRIPTION OF THE DRAWINGS

FIG. 1 is a hardware block diagram illustrating a schematic configuration example of a distance measurement apparatus according to a first exemplary embodiment.

FIG. 2 is a schematic diagram illustrating an overall configuration of a photoelectric conversion apparatus according to the first exemplary embodiment.

FIG. 3 is a schematic block diagram illustrating a configuration example of a sensor substrate according to the first exemplary embodiment.

FIG. 4 is a schematic block diagram illustrating a configuration example of a circuit substrate according to the first exemplary embodiment.

FIG. 5 is a schematic block diagram illustrating a configuration example of one pixel of the photoelectric conversion unit and a pixel signal processing unit according to the first exemplary embodiment.

FIGS. 6A to 6C are diagrams illustrating an operation of an avalanche photodiode according to the first exemplary embodiment.

FIG. 7 is a functional block diagram illustrating a schematic configuration example of the distance measurement apparatus according to the first exemplary embodiment.

FIG. 8 is a schematic diagram illustrating a distance measurement frame, a sub-frame, and a micro-frame according to the first exemplary embodiment.

FIG. 9 is a flowchart illustrating an operation in one distance measurement frame period of a distance image generation apparatus according to the first exemplary embodiment.

FIG. 10 is a drive timing diagram according to the first exemplary embodiment.

FIG. 11 is a schematic block diagram illustrating a configuration example of a circuit substrate according to a third exemplary embodiment.

FIG. 12 is a schematic block diagram illustrating a configuration example of a circuit substrate according to a second exemplary embodiment.

FIGS. 13A and 13B are a schematic diagram and a drive timing diagram, respectively, of a pixel array according to a fourth exemplary embodiment.

FIG. 14 is a schematic block diagram of a pixel according to a fifth exemplary embodiment.

FIG. 15 is a drive timing diagram according to the fifth exemplary embodiment.

FIGS. 16A and 16B are drive timing diagrams according to a sixth exemplary embodiment.

FIG. 17 is a functional block diagram of a photoelectric conversion system according to a seventh exemplary embodiment.

FIGS. 18A and 18B are functional block diagrams of a photoelectric conversion system according to an eighth exemplary embodiment.

FIG. 19 is a functional block diagram of a photoelectric conversion system according to a ninth exemplary embodiment.

FIGS. 20A and 20B are functional block diagrams of photoelectric conversion systems according to a tenth exemplary embodiment.

FIGS. 21A and 21B are functional block diagrams of photoelectric conversion systems according to an eleventh exemplary embodiment.

### DESCRIPTION OF THE EMBODIMENTS

The following exemplary embodiments are provided for embodying the technical idea of the disclosure but are not intended to limit the disclosure. The sizes and the positional relationship of members illustrated in the drawings are sometimes exaggerated for clarifying the description. In the following description, the same components are assigned the same reference numerals, and the description thereof will be sometimes omitted.

Hereinafter, exemplary embodiments of the disclosure will be described in detail with reference to the drawings. In the following description, terms (e.g., “up”, “down”, “right”, “left”, and other terms including these terms) indicating specific directions and positions are used as necessary. These terms are used to facilitate the understanding of the aspect of the embodiments described with reference to the drawings. The technical scope of the aspect of the embodiments is not limited by the meanings of these terms.

In this specification, a “planar view” refers to a view from a direction perpendicular to a light incidence surface of a semiconductor layer to be described below. A “cross-section” refers to a surface in the direction perpendicular to the light incidence surface of the semiconductor layer. In a case where the light incidence surface of the semiconductor layer is a rough surface when viewed microscopically, a planar view is defined based on a light incidence surface of a semiconductor layer that is set when viewed macroscopically.

The semiconductor layer has a first surface, and a second surface, which is a surface on the opposite side of the first surface and on which light enters.

In this specification, a depth direction refers to a direction extending from the first surface to the second surface of a semiconductor layer in which an avalanche photodiode (APD) is arranged. Hereinafter, the “first surface” is sometimes referred to as a “front surface”, and the “second surface” is sometimes referred to as a “rear surface”. A “depth” of a certain point or a certain region in the semiconductor layer means a distance of the point or the region from the first surface (front surface). If a point (or region) Z1 has a distance (depth) d1 from the first surface and a point (or region) Z2 has a distance (depth) d2 from the first surface and d1>d2 is satisfied, it is sometimes represented as “Z1 is deeper than Z2” or “Z2 is shallower than Z1”. If a point (or region) Z3 has a distance (depth) d3 from the first surface and d1>d3>d2 is satisfied, it is sometimes represented as “Z3 exists at a depth between Z1 and Z2” or “Z3 exists between Z1 and Z2 in the depth direction”.

In this specification, in a case where a term “impurity concentration” is used, the term means a net impurity concentration obtained by subtracting an amount compensated by an impurity of an opposite conductivity type. In other words, the “impurity concentration” refers to a NET doping concentration. A region in which a P-type additive impurity concentration is higher than an N-type additive impurity concentration is a P-type semiconductor region. In contrast, a region in which an N-type additive impurity concentration is higher than a P-type additive impurity concentration is an N-type semiconductor region.

In the following exemplary embodiments, the connection between elements of circuits will sometimes be described. In this case, even in a case where another element is interposed between target elements, the target elements are treated as being connected unless otherwise noted. For example, it is assumed that an element A is connected to one node of a capacitative element C having a plurality of nodes, and an element B is connected to the other node. Even in such a case, the elements A and B are connected unless otherwise noted.

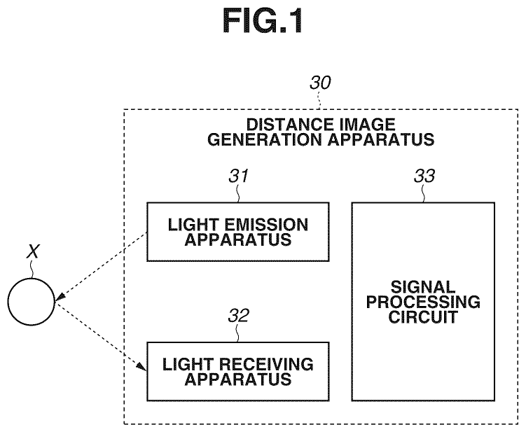

FIG. 1 is a hardware block diagram illustrating a schematic configuration example of a distance image generation apparatus 30 according to a first exemplary embodiment. The distance image generation apparatus 30 includes a light emission apparatus 31, a light receiving apparatus 32, and a signal processing circuit 33. The configuration of the distance image generation apparatus 30 to be described in the present exemplary embodiment is an example and is not limited to the configuration illustrated in FIG. 1.

The distance image generation apparatus 30 is an apparatus that measures a distance from the distance image generation apparatus 30 to a distance measurement target object X by using the technique of light detection and ranging (LiDAR). The distance image generation apparatus 30 measures a distance from the distance image generation apparatus 30 to the target object X based on a time lag from when light is emitted from the light emission apparatus 31, to when the emitted light is reflected by the target object X and received by the light receiving apparatus 32. By emitting laser light to a predetermined distance range including the target object X and receiving reflected light by using a pixel array, the distance image generation apparatus 30 can two-dimensionally measure a plurality of distances. The distance image generation apparatus 30 can thereby generate and output a distance image.

The light to be received by the light receiving apparatus 32 includes environmental light such as solar light in addition to reflected light from the target object X. Thus, the distance image generation apparatus 30 performs distance measurement with reduced influence of environmental light by using a method of measuring incident light in each of a plurality of periods (bin periods) and determines that reflected light enters in a bin period in which a light amount has reached a peak.

The light emission apparatus 31 is an apparatus that emits light, such as laser light, to the outside the distance image generation apparatus 30. The signal processing circuit 33 can include a processor that performs calculation processing of digital signals, and a memory that stores digital signals. The memory can be a semiconductor memory, such as a static random access memory (SRAM) and a dynamic random access memory (DRAM).

The light receiving apparatus 32 generates a pulse signal including a pulse that is based on incident light. The light receiving apparatus 32 is a photoelectric conversion apparatus including, for example, an avalanche photodiode (hereinafter, APD) as a photoelectric conversion element. In this case, if one photon enters an APD and a charge is generated, avalanche multiplication occurs and one pulse is generated in accordance with an avalanche current. Nevertheless, the light receiving apparatus 32 may be a photoelectric conversion apparatus that includes a photoelectric conversion element that uses, for example, a different photodiode.

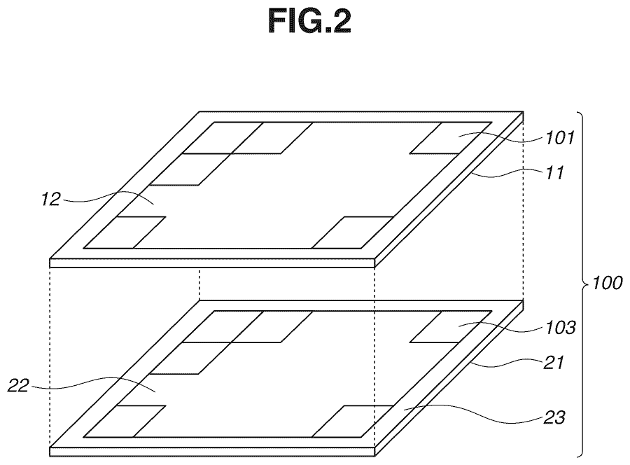

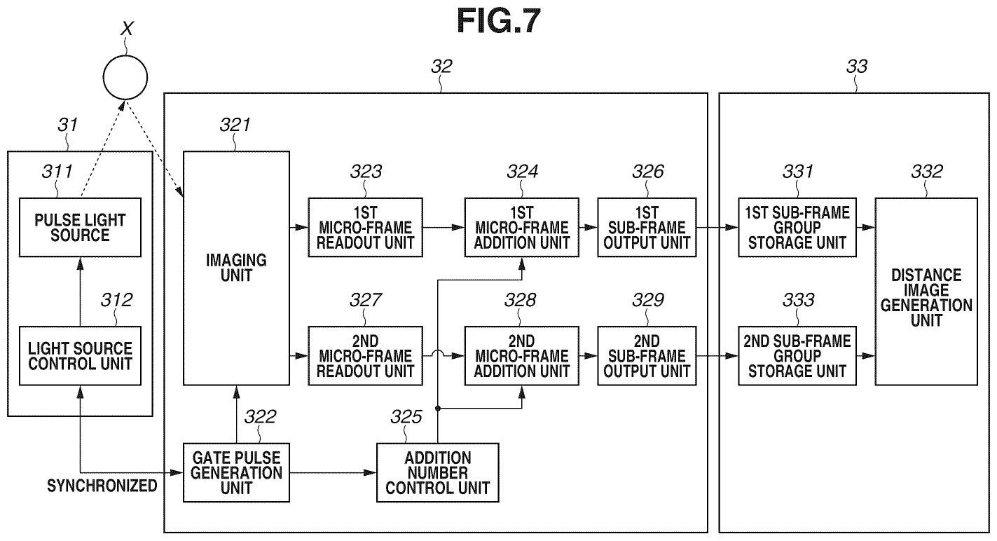

In the present exemplary embodiment, the light receiving apparatus 32 includes a pixel array in which pixels each including a photoelectric conversion element are arranged in an array including a plurality of rows and a plurality of columns. Here, a photoelectric conversion apparatus serving as a specific configuration example of the light receiving apparatus 32 will be described with reference to FIGS. 2 to 6C. The configuration example of the photoelectric conversion apparatus to be described below is an example. The photoelectric conversion apparatus applicable to the light receiving apparatus 32 is not limited to this and may be a photoelectric conversion apparatus that can implement the functions to be described below with reference to FIG. 7.

FIG. 2 is a schematic diagram illustrating an overall configuration of a photoelectric conversion apparatus 100 according to the present exemplary embodiment. The photoelectric conversion apparatus 100 includes a sensor substrate 11 (first substrate) and a circuit substrate 21 (second substrate) that are stacked on one another. The sensor substrate 11 and the circuit substrate 21 are electrically connected to each other. The sensor substrate 11 includes a pixel region 12 in which a plurality of pixels 101 are arranged to form a plurality of rows and a plurality of columns. The circuit substrate 21 includes a first circuit region 22 and a second circuit region 23. In the first circuit region 22, a plurality of pixel signal processing units 103 are arranged on a plurality of rows and a plurality of columns. The second circuit region 23 is arranged over the outer periphery of the first circuit region 22. The second circuit region 23 can include a circuit that controls the plurality of pixel signal processing units 103. The sensor substrate 11 has a light incidence surface that receives incident light, and a connection surface facing the light incidence surface. The sensor substrate 11 is connected with the circuit substrate 21 on the connection surface side. That is, the photoelectric conversion apparatus 100 is a so-called back-illuminated photoelectric conversion apparatus.

Hereinafter, the sensor substrate 11 and the circuit substrate 21 will be described as singulated chips. However, the sensor substrate 11 and the circuit substrate 21 are not limited to chips. For example, the sensor substrate 11 and the circuit substrate 21 may be wafers. In a case where the sensor substrate 11 and the circuit substrate 21 are singulated chips, the photoelectric conversion apparatus 100 may be manufactured by stacking in a wafer state and then singulating or may be manufactured by singulating and then singulating.

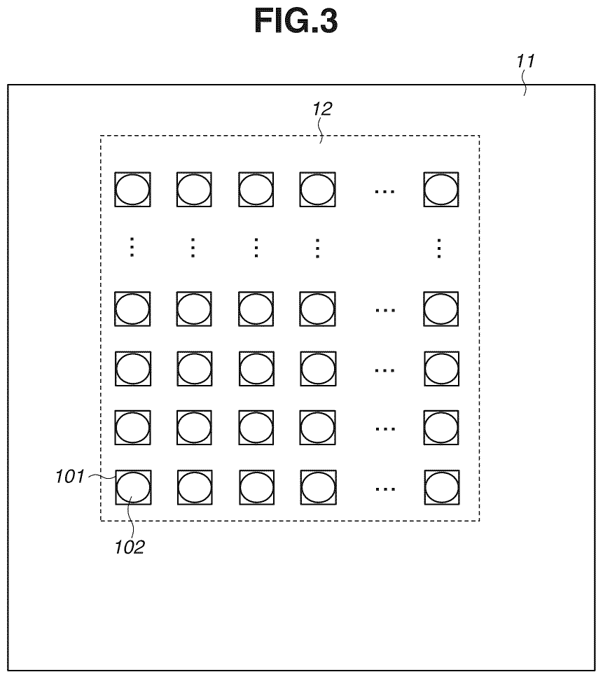

FIG. 3 is a schematic block diagram illustrating an arrangement example of the sensor substrate 11. In the pixel region 12, the plurality of pixels 101 are arranged to form a plurality of rows and a plurality of columns. Each of the plurality of pixels 101 includes, within the substrate, a photoelectric conversion unit 102 including an APD as a photoelectric conversion element.

Out of a charge pair to be generated in the APD, the conductivity type of a charge to be used as a signal charge will be referred to as a first conductivity type. The first conductivity type refers to a conductivity type in which charges of the same polarity as the polarity of signal charges are regarded as majority carriers. A conductivity type opposite to the first conductivity type (i.e., conductivity type in which charges of a polarity different from the polarity of signal charges are regarded as majority carriers) will be referred to as a second conductivity type. In the following description, an anode of the APD is set to a fixed potential, and a signal is taken out from a cathode of the APD. Accordingly, a semiconductor region of the first conductivity type is an N-type semiconductor region, and a semiconductor region of the second conductivity type is a P-type semiconductor region. A configuration in which a cathode of the APD is set to a fixed potential, and a signal is taken out from an anode of the APD may be employed. In this case, a semiconductor region of the first conductivity type is a P-type semiconductor region, and a semiconductor region of the second conductivity type is an N-type semiconductor region. The following description will be given of a case where one node of the APD is set to a fixed potential, but potentials of both nodes may be made variable.

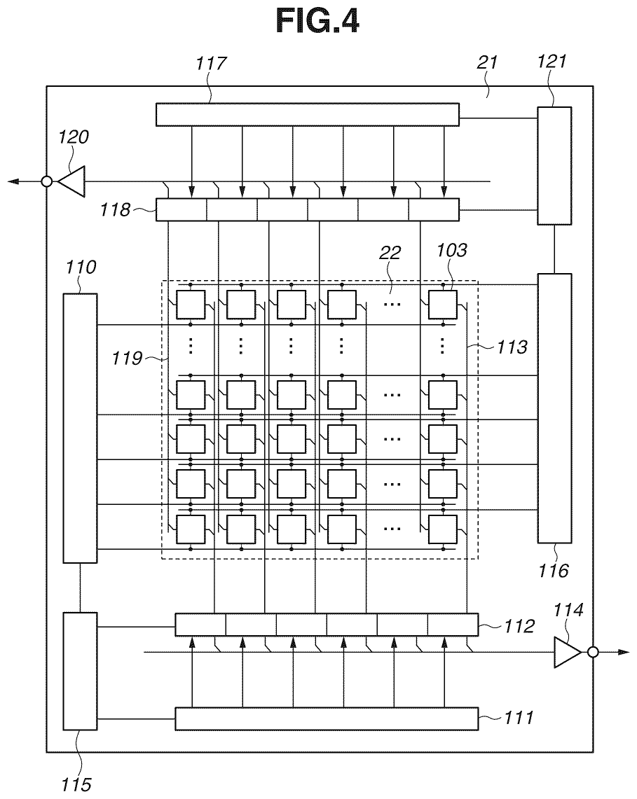

FIG. 4 is a schematic block diagram illustrating a configuration example of the circuit substrate 21. The circuit substrate 21 includes the first circuit region 22 in which the plurality of pixel signal processing units 103 are arranged to form a plurality of rows and a plurality of columns.

In the circuit substrate 21, a first vertical scanning circuit 110, a first horizontal scanning circuit 111, a first readout circuit 112, a first pixel output signal line 113, a first output circuit 114, and a first control signal generation unit 115 are arranged. In the circuit substrate 21, a second vertical scanning circuit 116, a second horizontal scanning circuit 117, a second readout circuit 118, a second pixel output signal line 119, a second output circuit 120, and a second control signal generation unit 121 are also arranged. The plurality of photoelectric conversion units 102 illustrated in FIG. 3 and the plurality of pixel signal processing units 103 illustrated in FIG. 4 are electrically connected via connection lines respectively provided for the pixels 101. In the present exemplary embodiment, the pixel signal processing unit 103 is configured to be able to output, from the pixel 101, two types of signals (first signal, second signal) with different exposure periods.

The first control signal generation unit 115 is a control circuit that generates control signals for driving the first vertical scanning circuit 110, the first horizontal scanning circuit 111, and the first readout circuit 112, and supplies the control signals to these components. The first control signal generation unit 115 thereby controls drive timings of the components. In addition, the second control signal generation unit 121 is a control circuit that generates control signals for driving the second vertical scanning circuit 116, the second horizontal scanning circuit 117, and the second readout circuit 118, and supplies the control signals to these components. The second control signal generation unit 121 thereby controls drive timings of the components.

The first vertical scanning circuit 110 supplies a control signal to each of the plurality of pixel signal processing units 103 based on a control signal supplied from the first control signal generation unit 115. The first vertical scanning circuit 110 supplies a control signal to the pixel signal processing units 103 for each row via a first drive line provided for each row in the first circuit region 22. As described below, a plurality of first drive lines can be provided for each row. A logic circuit, such as a shift register or an address decoder, can be used as the first vertical scanning circuit 110. The first vertical scanning circuit 110 thereby selects a row on which the first signal is to be output from the pixel signal processing unit 103.

The second vertical scanning circuit 116 supplies a control signal to each of the plurality of pixel signal processing units 103 based on a control signal supplied from the second control signal generation unit 121. The second vertical scanning circuit 116 supplies a control signal to the pixel signal processing units 103 for each row via a second drive line provided for each row in the first circuit region 22. As described below, a plurality of second drive lines can be provided for each row. A logic circuit, such as a shift register or an address decoder, can be used as the second vertical scanning circuit 116. The second vertical scanning circuit 116 thereby selects a row on which the second signal is to be output from the pixel signal processing unit 103.

A signal output from the photoelectric conversion unit 102 of the pixel 101 is processed by the pixel signal processing units 103. By counting the number of pulses output from the APD included in the photoelectric conversion unit 102, the pixel signal processing unit 103 acquires and holds a digital signal having a plurality of bits.

The first horizontal scanning circuit 111 supplies a control signal to the first readout circuit 112 based on a control signal supplied from the first control signal generation unit 115. The pixel signal processing units 103 are connected to the first readout circuit 112 via the first pixel output signal line 113 provided for each column in the first circuit region 22. The first pixel output signal line 113 for one column is shared by a plurality of pixel signal processing units 103 on a corresponding column. The first pixel output signal lines 113 include a plurality of lines. The first pixel output signal line 113 at least has a function of outputting a digital signal to the first readout circuit 112 from each of the pixel signal processing units 103, and a function of supplying a control signal for selecting a column from which signals are to be output, to the pixel signal processing units 103. Based on the control signal supplied from the first control signal generation unit 115, the first readout circuit 112 outputs a signal via the first output circuit 114 to a unit or a signal processing unit outside the photoelectric conversion apparatus 100.

Based on the control signal supplied from the second control signal generation unit 121, the second horizontal scanning circuit 117 supplies a control signal to the second readout circuit 118. The pixel signal processing units 103 are connected with the second readout circuit 118 via the second pixel output signal line 119 provided for each column in the first circuit region 22. The second pixel output signal line 119 for one column is shared by a plurality of pixel signal processing units 103 on a corresponding column. The second pixel output signal line 119 include a plurality of lines. The second pixel output signal line 119 at least has a function of outputting a digital signal to the second readout circuit 118 from each of the pixel signal processing units 103, and a function of supplying a control signal for selecting a column from which signals are to be output, to the pixel signal processing units 103. Based on the control signal supplied from the second control signal generation unit 121, the second readout circuit 118 outputs a signal via the second output circuit 120 to a storage unit or a signal processing unit outside the photoelectric conversion apparatus 100.

The photoelectric conversion units 102 may be one-dimensionally arrayed in the pixel region 12. The pixel signal processing units 103 may not be provided in such a manner as to respectively correspond to all the pixels 101. For example, one pixel signal processing unit 103 may be shared by a plurality of pixels 101. In this case, the pixel signal processing unit 103 provides a function of signal processing to the pixels 101 by sequentially processing signals output from the photoelectric conversion units 102.

As illustrated in FIGS. 3 and 4, the first circuit region 22 in which a plurality of pixel signal processing units 103 is arranged is arranged in a region overlapping the pixel region 12 in a planar view. The first vertical scanning circuit 110, the first horizontal scanning circuit 111, the first readout circuit 112, the first output circuit 114, and the first control signal generation unit 115 are then arranged in such a manner as to overlap, in a planar view, a region defined by the ends of the sensor substrate 11 and the ends of the pixel region 12. In a similar manner, the second vertical scanning circuit 116, the second horizontal scanning circuit 117, the second readout circuit 118, the second output circuit 120, and the second control signal generation unit 121 are also arranged in such a manner as to overlap the region defined by the ends of the sensor substrate 11 and the ends of the pixel region 12. In other words, the sensor substrate 11 includes the pixel region 12, and a non-pixel region arranged around the pixel region 12. On the circuit substrate 21, the second circuit region 23 (described above with reference to FIG. 2) is then arranged in a region overlapping the non-pixel region in a planar view. In the second circuit region 23, the first vertical scanning circuit 110, the first horizontal scanning circuit 111, the first readout circuit 112, the first output circuit 114, the first control signal generation unit 115, the second vertical scanning circuit 116, the second horizontal scanning circuit 117, the second readout circuit 118, the second output circuit 120, and the second control signal generation unit 121 are arranged.

The arrangement of the first pixel output signal line 113, the arrangement of the first readout circuit 112, and the arrangement of the first output circuit 114 are not limited to those illustrated in FIG. 4. For example, the first pixel output signal line 113 may be arranged to extend in a row direction and may be shared by a plurality of pixel signal processing units 103 on a corresponding row. The first readout circuit 112 may be arranged in such a manner that the first pixel output signal lines 113 of the rows are connected thereto.

In a similar manner, the arrangement of the second pixel output signal line 119, the arrangement of the second readout circuit 118, and the arrangement of the second output circuit 120 are not limited to those illustrated in FIG. 4. For example, the second pixel output signal line 119 may be arranged to extend in a row direction and may be shared by a plurality of pixel signal processing units 103 on a corresponding row. The second readout circuit 118 may be arranged in such a manner that the second pixel output signal lines 119 of the rows are connected thereto.

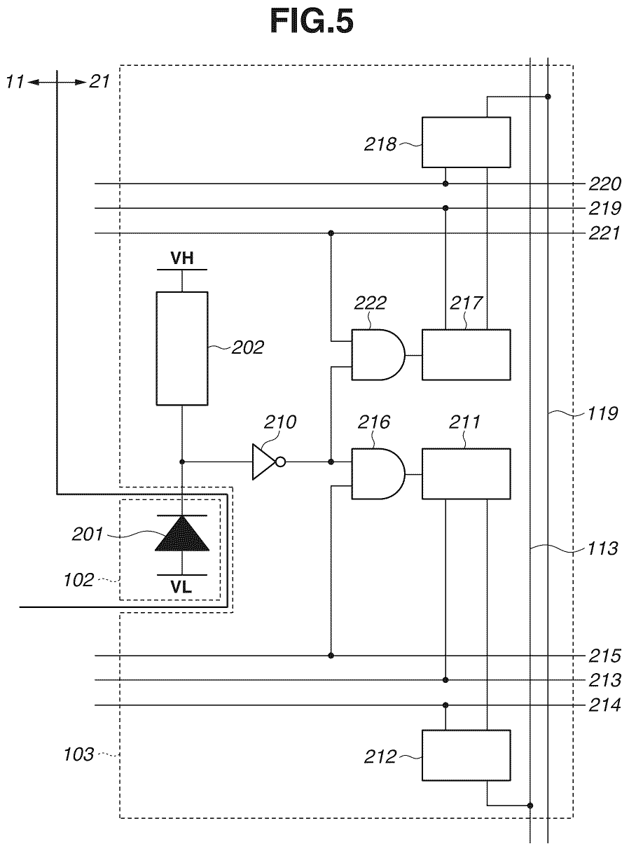

FIG. 5 is a schematic block diagram illustrating a configuration example of one pixel of the photoelectric conversion unit 102 and the pixel signal processing unit 103 according to the present exemplary embodiment. FIG. 5 schematically illustrates a specific configuration example including a connection relationship between the photoelectric conversion unit 102 arranged on the sensor substrate 11 and the pixel signal processing unit 103 arranged on the circuit substrate 21. In FIG. 5, drive lines between the first vertical scanning circuit 110 and the pixel signal processing unit 103 in FIG. 4 are illustrated as drive lines 213, 214, and 215. In a similar manner, drive lines between the second vertical scanning circuit 116 and the pixel signal processing unit 103 are illustrated as drive lines 219, 220, and 221.

The photoelectric conversion unit 102 includes an APD 201. The pixel signal processing unit 103 includes a quench element 202, a waveform shaping unit 210, a first counter circuit 211, a first selection circuit 212, and a first gating circuit 216. The pixel signal processing unit 103 further includes a second counter circuit 217, a second selection circuit 218, and a second gating circuit 222.

The APD 201 generates a charge corresponding to incident light through photoelectric conversion. A voltage VL (first voltage) is supplied to an anode of the APD 201. A cathode of the APD 201 is connected to a first terminal of the quench element 202 and an input terminal of the waveform shaping unit 210. A voltage VH (second voltage), which is higher than the voltage VL supplied to the anode of the APD 201, is supplied to the cathode of the APD 201. Between the anode and the cathode of the APD 201, a reverse bias voltage is supplied so that the APD 201 performs an avalanche multiplication operation. If a charge is generated by incident light in the APD 201 to which the reverse bias voltage is supplied, this charge causes avalanche multiplication and an avalanche current is generated.

In a case where a reverse bias voltage is supplied, the APD 201 is operated in a Geiger mode or a linear mode. In the Geiger mode, the APD 201 is operated with a potential difference between the anode and the cathode that is larger than a breakdown voltage. In the linear mode, the APD 201 is operated with a potential difference between the anode and the cathode that is near a breakdown voltage, or with a potential difference smaller than or equal to the breakdown voltage.

An APD operated in the Geiger mode is referred to as a single photon avalanche diode (SPAD). At this time, the voltage VL (first voltage) is −30 V (volts) and the voltage VH (second voltage) is 1 V, for example. The APD 201 may be operated in the linear mode or in the Geiger mode. In the case of a SPAD, a potential difference becomes larger and an avalanche multiplication effect becomes more prominent as compared with an APD in the linear mode, and thus SPADs are used.

The quench element 202 functions as a load circuit (quench circuit) when a signal is multiplied by avalanche multiplication. The quench element 202 suppresses avalanche multiplication by suppressing a voltage supplied to the APD 201 (quench operation). The quench element 202 also returns a voltage supplied to the APD 201, to the voltage VH by flowing a current by an amount corresponding to a voltage drop caused by the quench operation (recharge operation). The quench element 202 can be, for example, a resistive element.

The waveform shaping unit 210 shapes a potential change of the cathode of the APD 201 that is obtained at the time of photon detection, and outputs a pulse signal. The waveform shaping unit 210 is, for example, an inverter circuit. FIG. 5 illustrates an example in which one inverter is used for the waveform shaping unit 210. However, the waveform shaping unit 210 may be a circuit in which a plurality of inverters is connected in series or another circuit having a waveform shaping effect.

The first gating circuit 216 and the second gating circuit 222 are circuits that perform gating in such a manner as to pass pulse signals output from the waveform shaping unit 210 for a predetermined period of time. An input terminal of the first gating circuit 216 and an input terminal of the second gating circuit 222 are connected in parallel to an output terminal of the APD 201. During a period in which pulse signals can pass through the first gating circuit 216, photons incident on the APD 201 are counted by the first counter circuit 211, which is provided as a subsequent circuit. In a similar manner, during a period in which pulse signals can pass through the second gating circuit 222, photons incident on the APD 201 are counted by the second counter circuit 217, which is provided as a subsequent circuit. The first gating circuit 216 and the second gating circuit 222 thus control a period in which signal generation that is based on incident light is performed in the pixel 101. The period in which pulse signals can pass through each gating circuit is controlled based on a control signal supplied from the first vertical scanning circuit 110 via the drive line 215 and a control signal supplied from the second vertical scanning circuit 116 via the drive line 221. FIG. 5 illustrates an example in which each of the first gating circuit 216 and the second gating circuit 222 includes one AND circuit. A pulse signal is input to one of two input terminals of the AND circuit used as the first gating circuit 216, and a control signal supplied from the first vertical scanning circuit 110 is input to the other input terminal via the drive line 215. A pulse signal is input to one of two input terminals of the AND circuit used as the second gating circuit 222, and a control signal supplied from the second vertical scanning circuit 116 is input to the other input terminal via the drive line 221. The AND circuit serving as the first gating circuit 216 outputs a logical product of these to the first counter circuit 211, and the AND circuit serving as the second gating circuit 222 outputs a logical product of these to the second counter circuit 217. The first gating circuit 216 and the second gating circuit 222 are only required to implement gating and may have a circuit configuration other than the AND circuit.

The first counter circuit 211 counts the pulse signals output from the waveform shaping unit 210 via the first gating circuit 216 and holds a digital signal indicating a count value.

When a control signal is supplied from the first vertical scanning circuit 110 via the drive line 213, the first counter circuit 211 resets the held signal.

The second counter circuit 217 counts the pulse signals output from the waveform shaping unit 210 via the second gating circuit 222 and holds a digital signal indicating a count value.

When a control signal is supplied from the second vertical scanning circuit 116 via the drive line 219, the second counter circuit 217 resets the held signal.

A control signal is supplied to the first selection circuit 212 from the first vertical scanning circuit 110 illustrated in FIG. 4, via the drive line 214 illustrated in FIG. 5. In accordance with this control signal, the first selection circuit 212 switches electric connection and separation between the first counter circuit 211 and the first pixel output signal line 113. The first selection circuit 212 includes a buffer circuit for outputting a signal corresponding to a value held in the first counter circuit 211, for example.

A control signal is supplied to the second selection circuit 218 from the second vertical scanning circuit 116 illustrated in FIG. 4, via the drive line 220 illustrated in FIG. 5. In accordance with this control signal, the second selection circuit 218 switches electric connection and separation between the second counter circuit 217 and the second pixel output signal line 119. The second selection circuit 218 includes a buffer circuit for outputting a signal corresponding to a value held in the second counter circuit 217, for example.

In the example illustrated in FIG. 5, the first selection circuit 212 and the second selection circuit 218 switch electric connection and separation between the first counter circuit 211 and the first pixel output signal line 113, and between the second counter circuit 217 and the second pixel output signal line 119, respectively. Nevertheless, a method of controlling signal output to the first pixel output signal line 113 and the second pixel output signal line 119 is not limited to this. For example, a switch, such as a transistor, may be arranged at a node between the quench element 202 and the APD 201, or between the photoelectric conversion unit 102 and the pixel signal processing unit 103. By switching electric connection and separation of these switches, signal output to the first pixel output signal line 113 and the second pixel output signal line 119 may be controlled. By changing the value of the voltage VH or the voltage VL supplied to the photoelectric conversion unit 102, using a switch, such as a transistor, signal output to the first pixel output signal line 113 and the second pixel output signal line 119 may be controlled.

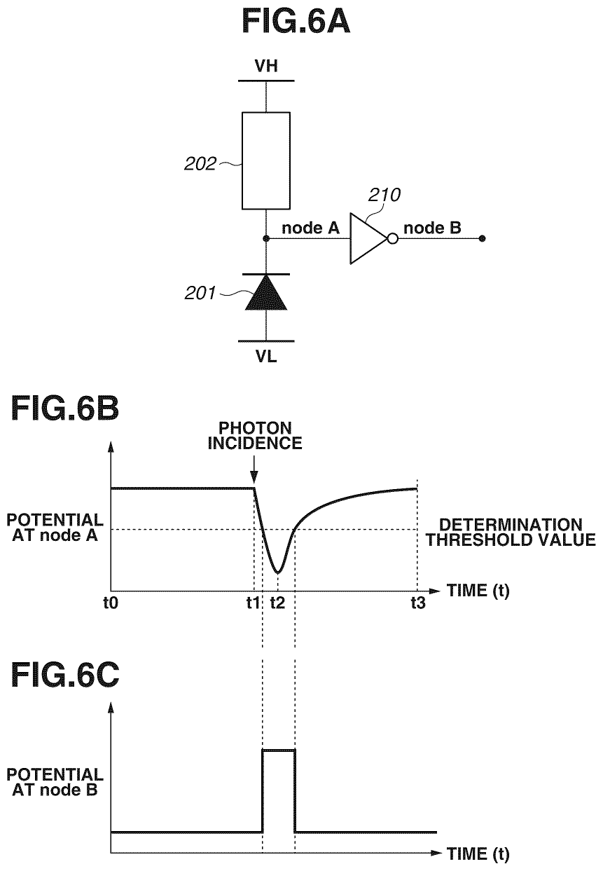

FIGS. 6A, 6B, and 6C are diagrams illustrating an operation of the APD 201 according to the present exemplary embodiment. FIG. 6A is a diagram illustrating the APD 201, the quench element 202, the waveform shaping unit 210 extracted from FIG. 5. As illustrated in FIG. 6A, a connection node of the APD 201, the quench element 202, and an input terminal of the waveform shaping unit 210 is regarded as a node A. As illustrated in FIG. 6A, an output side of the waveform shaping unit 210 is regarded as a node B.

FIG. 6B is a graph indicating a temporal change in potential at the node A illustrated in FIG. 6A.

FIG. 6C is a graph indicating a temporal change in potential at the node B illustrated in FIG. 6A. During a period from a time t0 to a time t1, a voltage VH-VL is applied to the APD 201 in FIG. 6A. If a photon enters the APD 201 at the time t1, avalanche multiplication occurs in the APD 201. An avalanche multiplication current accordingly flows to the quench element 202, and a potential at the node A drops. Thereafter, a potential drop amount further increases, and a voltage applied to the APD 201 gradually becomes smaller. Avalanche multiplication in the APD 201 then stops at a time t2. A voltage level at the node A accordingly stops dropping from a certain fixed value. Thereafter, a current compensating for a voltage drop from the voltage VL flows to the node A during a period from the time t2 to a time t3, and the potential level of the node A is statically settled at the original potential at the time t3.

In the above-described process, the potential at the node B becomes a high level during a period in which the potential at the node A is lower than a threshold value. In this manner, a waveform of a potential drop at the node A that is caused by photon incidence is subjected to waveform shaping performed by the waveform shaping unit 210, and output as a pulse to the node B.

Next, the configuration and the operation of the entire distance image generation apparatus 30 will be described in more detail. FIG. 7 is a functional block diagram illustrating a schematic configuration example of the distance image generation apparatus 30 according to the present exemplary embodiment. FIG. 7 illustrates a detailed configuration of the light emission apparatus 31, the light receiving apparatus 32, and the signal processing circuit 33 illustrated in FIG. 1.

The light emission apparatus 31 includes a pulse light source 311 and a light source control unit 312. The pulse light source 311 is a light source, such as a semiconductor laser apparatus, that emits pulse light to the inside of the entire distance measurement range. The pulse light source 311 can be a surface light source, such as a surface-emitting laser. The light source control unit 312 is a control circuit that controls a light emission timing of the pulse light source 311.

The light receiving apparatus 32 includes an imaging unit 321, a gate pulse generation unit 322, a first micro-frame readout unit 323, a first micro-frame addition unit 324, an addition number control unit 325, and a first sub-frame output unit 326. The light receiving apparatus 32 further includes a second micro-frame readout unit 327, a second micro-frame addition unit 328, and a second sub-frame output unit 329. As described above, the imaging unit 321 can be a photoelectric conversion apparatus including a pixel array in which pixel circuits each including the APD 201 are two-dimensionally arranged. The distance image generation apparatus 30 can thereby acquire a two-dimensional distance image.

The gate pulse generation unit 322 is a control circuit that outputs a control signal for controlling a drive timing of the imaging unit 321. The gate pulse generation unit 322 also synchronously controls the pulse light source 311 and the imaging unit 321 by transmitting and receiving control signals to and from the light source control unit 312. This enables image capturing to be performed while controlling a time lag from when light is emitted from the pulse light source 311 to when the light is received by the imaging unit 321. In the present exemplary embodiment, the gate pulse generation unit 322 performs global gate drive of the imaging unit 321. The global gate drive is a drive method of simultaneously performing incident light detection during the same exposure period in several pixels (pixel group) in the imaging unit 321 with reference to an emission time of pulse light from the pulse light source 311. In the global gate drive according to the present exemplary embodiment, incident light detection is repeatedly performed while sequentially shifting timings from light emission to batch exposure. The pixels of the imaging unit 321 thereby simultaneously generate one-bit signals indicating the existence or non-existence of an incident photon in each of a plurality of exposure periods. The generated one-bit signals can be held in the first counter circuit 211 and the second counter circuit 217. In this case, the first counter circuit 211 and the second counter circuit 217 each include a one-bit counter (memory circuit). Hereinafter, the first counter circuit 211 and the second counter circuit 217 will be referred to as a first memory circuit 211 and a second memory circuit 217, respectively.

The global gate drive is implemented by a signal maintained at a high level during a gating period, being input to input terminals of the first gating circuits 216 and the second gating circuits 222 of the plurality of pixels 101 based on a control signal from the gate pulse generation unit 322. It is assumed that the period in which a signal input to the first gating circuit 216 is at the high level, and the period in which a signal input to the second gating circuit 222 is at the high level are assumed to be difficult. However, the periods may overlap each other partially or entirely. The period in which a signal input to the first gating circuit 216 is at the high level, and the period in which a signal input to the second gating circuit 222 is at the high level may be completely the same.

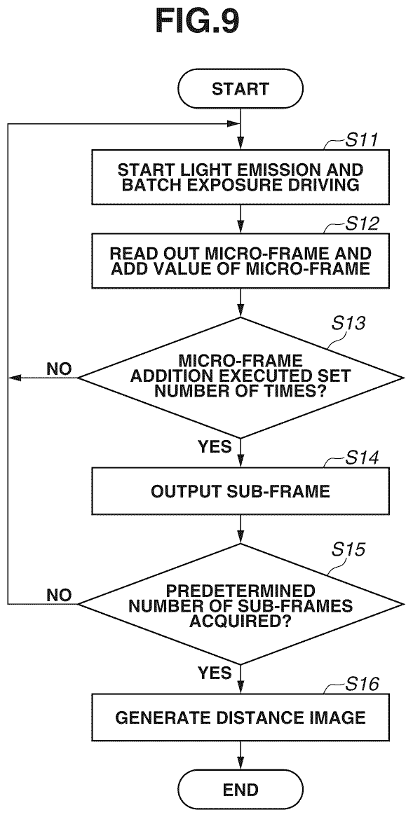

The first micro-frame readout unit 323, the first micro-frame addition unit 324, and the addition number control unit 325, the second micro-frame readout unit 327, and the second micro-frame addition unit 328 read out a one-bit signal constituting a micro-frame, from the imaging unit 321. These circuits are signal processing circuits that perform predetermined signal processing on the read one-bit signal. The details of operations of these components will be described below with reference to FIG. 9. The first sub-frame output unit 326 and the second sub-frame output unit 329 are interfaces that output signals from the light receiving apparatus 32 to the signal processing circuit 33 in accordance with a predetermined standard. The first sub-frame output unit 326 and the second sub-frame output unit 329 transmit signals from a memory in the light receiving apparatus 32 to a memory in the signal processing circuit 33.

The signal processing circuit 33 includes a first sub-frame group storage unit 331, a second sub-frame group storage unit 333, and a distance image generation unit 332. The signal processing circuit 33 is a computer including a processor operating as the distance image generation unit 332, and a memory operating as the first sub-frame group storage unit 331 and the second sub-frame group storage unit 333. Details of operations of these components will also be described below with reference to FIG. 9.

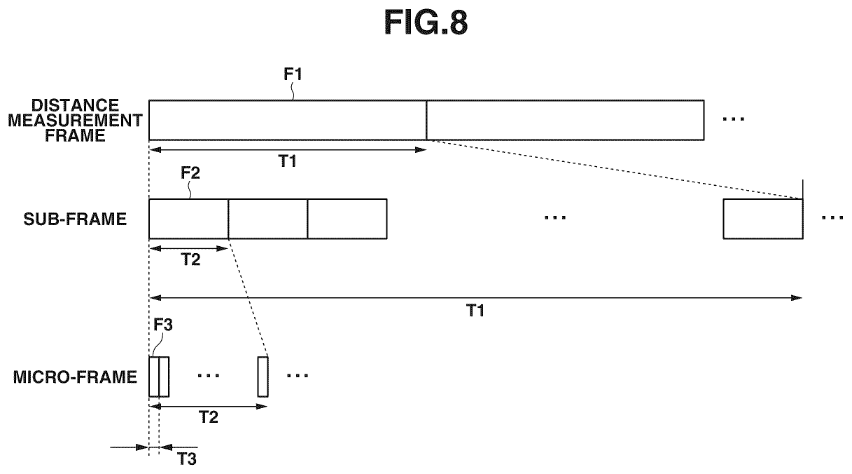

Next, precedential to the description of the drive method according to the present exemplary embodiment, configurations of a distance measurement frame, a sub-frame, and a micro-frame will be described with reference to FIG. 8. FIG. 8 schematically illustrates acquisition periods of a distance measurement frame corresponding to a distance image, a sub-frame to be used for the generation of the distance measurement frame, and a micro-frame to be used for the generation of the sub-frame, by arranging blocks in a traverse direction. In FIG. 8, the traverse direction indicates a lapse of time, and one block indicates an acquisition period for one distance measurement frame, one sub-frame, or one micro-frame.

A distance measurement frame F1 corresponds to one distance image. That is, the distance measurement frame F1 includes information regarding a distance to the target object X that is calculated from a time lag between light emission and light reception, for each of a plurality of pixels. In the present exemplary embodiment, a distance image is assumed to be acquired as a moving image, and each time one distance measurement frame period T1 elapses, the acquisition of one distance measurement frame F1 is repeatedly performed.

One distance measurement frame F1 is composed of a plurality of sub-frames F2. One distance measurement frame period T1 includes a plurality of sub-frame periods T2. Each time one sub-frame period T2 elapses, the acquisition of one sub-frame F2 is repeatedly performed. The sub-frame F2 is composed of a multibit signal corresponding to an amount of light that has entered during the sub-frame period T2.

One sub-frame F2 is composed of a plurality of micro-frames F3. One sub-frame period T2 includes a plurality of micro-frame periods T3. Each time one micro-frame period T3 elapses, the acquisition of one micro-frame F3 is repeatedly performed. The micro-frame F3 includes a one-bit signal indicating the existence of incident light on a photoelectric conversion element during the micro-frame period T3. By performing additive synthesis of a plurality of micro-frames including one-bit signal, one sub-frame F2 including a multibit signal is generated. One sub-frame F2 can thereby include a multibit signal corresponding to the number of micro-frames in which incident light is detected within the sub-frame period T2.

In this manner, a plurality of sub-frames F2 with mutually-different incident light acquisition periods are acquired. This signal acquisition time can be associated with a distance from a distance image generation apparatus to a distance measurement target. Then, based on a distribution of signal acquisition times and signal values of a plurality of sub-frames F2, a signal acquisition time at which a signal value becomes the largest can be determined. Since it is estimated that reflected light has entered the imaging unit 321 at a time when a signal value becomes the largest, the distance can be calculated by converting the signal acquisition time at which a signal value becomes the largest into a distance to the target object X. By calculating a distance for each pixel and acquiring a two-dimensional distribution of distances, a distance image can be generated.

As illustrated in FIG. 8, the length of the distance measurement frame period T1 to be used for acquisition of one distance measurement frame F1 depends on the number of sub-frames F2. Since the number of sub-frames F2 is a parameter corresponding to the number of distance measurement points, a tradeoff relationship exists between a distance resolution and a frame rate.

FIG. 9 illustrates a drive method of a distance image generation apparatus for one distance measurement frame period T1. The drive method according to the present exemplary embodiment will be described along with a flowchart in FIG. 9.

In the flowchart illustrated in FIG. 9, the processing from “start” to “end” illustrates processing to be performed during the distance measurement frame period T1 in which one distance measurement frame F1 is to be acquired in FIG. 8. One-round processing in the loop from steps S11 to S15 illustrates processing to be performed in the sub-frame period T2 in which one sub-frame F2 is to be acquired in FIG. 8. One-round processing in the loop from steps S11 to S13 illustrates processing to be performed in the micro-frame period T3 in which one micro-frame F3 is to be acquired in FIG. 8.

In step S11, the light source control unit 312 controls the pulse light source 311 to emit pulse light to a predetermined distance measurement range. Synchronously with this, the gate pulse generation unit 322 controls the imaging unit 321 to start incident light detection using the global gate drive. Here, the gate pulse generation unit 322 generates gate pulses indicating different detection periods with respect to the first gating circuit 216 and the second gating circuit 222.

In step S12, the first micro-frame readout unit 323 and the second micro-frame readout unit 327 each read out a micro-frame from the imaging unit 321 each time the micro-frame period T3 elapses. The first micro-frame readout unit 323 reads out one-bit signal included in a first micro-frame that is held in the first memory circuit 211. The second micro-frame readout unit 327 reads out one-bit signal included in a second micro-frame that is held in the second memory circuit 217. The read micro-frames are held in a memory of the first micro-frame addition unit 324 and the second micro-frame addition unit 328. This memory has a storage capacity that can store multibit data for each pixel. The first micro-frame addition unit 324 and the second micro-frame addition unit 328 sequentially add a value of a micro-frame to a value held in the memory, each time a micro-frame is read out. The first micro-frame addition unit 324 and the second micro-frame addition unit 328 thereby add a plurality of micro-frames within the sub-frame period T2 and generate a sub-frame. The number of times of addition performed by the first micro-frame addition unit 324 and the second micro-frame addition unit 328 is controlled by the addition number control unit 325. To execute the control, the addition number control unit 325 holds information regarding a preset number of times of addition. In this manner, the first micro-frame readout unit 323 and the second micro-frame readout unit 327 function as an acquisition unit that acquires a micro-frame including a one-bit signal that is based on incident light on a photoelectric conversion element. The first micro-frame addition unit 324 and the second micro-frame addition unit 328 also function as a synthesis unit that synthesizes a plurality of micro-frames acquired in mutually-different periods. For example, if the number of times of addition is 64, it is possible to generate a signal of a sub-frame having a six-bit gradation by synthesizing 64 micro-frames.

In step S13, the first micro-frame addition unit 324 and the second micro-frame addition unit 328 determines whether micro-frame addition has been executed a preset number of times. In a case where micro-frame addition has not been executed a preset number of times (NO in step S13), the processing proceeds to step S11, and the next micro-frame is read out. In a case where micro-frame addition has been executed a preset number of times (YES in step S13), the processing proceeds to step S14.

In step S14, the first sub-frame output unit 326 reads out a sub-frame of which addition has been completed, from the memory of the first micro-frame addition unit 324, and outputs the sub-frame to the first sub-frame group storage unit 331. In a similar manner, the second sub-frame output unit 329 reads out a sub-frame of which addition has been completed, from the memory of the second micro-frame addition unit 328, and outputs the sub-frame to the second sub-frame group storage unit 333. The first sub-frame group storage unit 331 stores the sub-frame output from the first sub-frame output unit 326. The second sub-frame group storage unit 333 stores the sub-frame output from the second sub-frame output unit 329. The first sub-frame group storage unit 331 and the second sub-frame group storage unit 333 are configured to individually store a plurality of sub-frames to be used for the generation of one distance measurement frame, for each sub-frame period.

In step S15, the signal processing circuit 33 determines whether a predetermined number (i.e., the number of distance measurement points) of sub-frames have been acquired by the first sub-frame group storage unit 331 and the second sub-frame group storage unit 333. In a case where the predetermined number (i.e., the number of distance measurement points) of sub-frames have not been acquired (NO in step S15), the processing returns to step S11, and the acquisition and addition of a plurality of micro-frames are performed again to read out the next sub-frame. In this case, similar processing is performed with a start time of the global gate drive with respect to a light emission time is shifted (gate shift) only by one sub-frame period. In a case where the predetermined number (i.e., the number of distance measurement points) of sub-frames have been acquired (YES in step S15), the processing proceeds to step S16. By using the loop from steps S11 to S15, the predetermined number (i.e., the number of distance measurement points) of sub-frames are acquired.

In step S16, the distance image generation unit 332 acquires a plurality of sub-frames in one distance measurement frame period T1 from the first sub-frame group storage unit 331 and the second sub-frame group storage unit 333. By calculating a distance corresponding to a sub-frame in which a signal value becomes the largest, for each pixel, the distance image generation unit 332 generates a distance image indicating a two-dimensional distribution of distances. The distance image generation unit 332 then outputs a distance image to an external apparatus of the signal processing circuit 33. This distance image can be used for the detection of a surrounding environment of a vehicle, for example. The distance image generation unit 332 can store a distance image into an internal memory of a distance image generation apparatus.

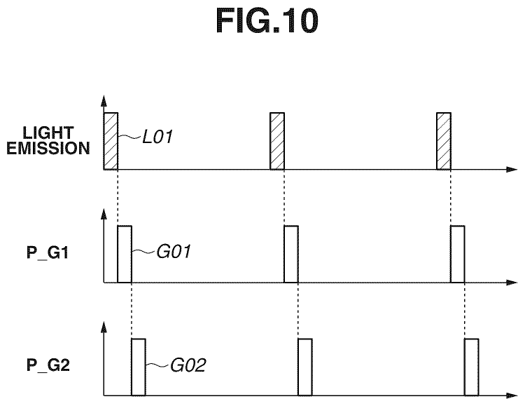

In the present exemplary embodiment, two micro-frames can be acquired for each pixel in the imaging unit 321. Exposure periods (set in step S11 in FIG. 9) to read out the two micro-frames differ from each other. A specific example thereof will be described with reference to FIG. 10. FIG. 10 is a drive timing diagram indicating a timing of a gate pulse according to the present exemplary embodiment.

In FIG. 10, “light emission” indicates a light emission timing of the pulse light source 311. As illustrated in FIG. 10, the pulse light source 311 emits light at a fixed cycle in accordance with the control performed by the light source control unit 312.

In FIG. 10, “P_G1” and “P_G2” indicate input timings of a plurality of types of gate pulses to be input from the gate pulse generation unit 322 to the imaging unit 321.

The input timing indicated by “P_G1” corresponds to the input timing of a control signal to be input to the first gating circuit 216 via the drive line 215 in FIG. 5. The input timing indicated by “P_G2” corresponds to the input timing of a control signal to be input to the second gating circuit 222 via the drive line 221 in FIG. 5. Gate pulses synchronized with a light emission timing L01 are regarded as a gate pulse G01 and a gate pulse G02. Although the gate pulse G01 and the gate pulse G02 become the high level after a lapse of a predetermined time from light emission of the pulse light source 311, periods in which the gate pulse G01 and the gate pulse G02 become the high level within one micro-frame period T3 differ from each other. In other words, the gate pulse G01 becomes the high level at a time at which a first time period elapses from light emission of the pulse light source 311 (first exposure period), and the gate pulse G02 becomes the high level at a time at which a second time period elapses from light emission of the pulse light source 311 (second exposure period). The first time period and the second time period are mutually-different periods, and both time periods are shorter than the length of a micro-frame period T3.

In this manner, it is possible to vary exposure periods to read out two micro-frames that are to be acquired for each pixel in the imaging unit 321 by making the timings at which the gate pulse G01 and the gate pulse G02 become the high level different from each other. It is thus possible to measure two types of distance measurement points within one micro-frame period T3.

As described above, one sub-frame is generated by adding a plurality of micro-frames. That is, signals for generation of sub-frames at mutually-different distance measurement points are output for each pixel in the imaging unit 321. When one sub-frame is generated, a timing of a gate pulse in each pixel is gate-shifted, at the start of a following sub-frame period, from the timing of a gate pulse of a current sub-frame period by a predetermined time interval.

By using such a gate shift, a predetermined period corresponding to each sub-frame period can be set as an exposure period.

In contrast, as illustrated in FIG. 10, if the periods at which the gate pulse G01 and the gate pulse G02 become the high-level neighbor each other, “1” is set in the first memory circuit 211 and “1” is simultaneously set also in the second memory circuit 217 in some cases if a photon is detected in the period in which the gate pulse G01 is at the high level. To prevent such double count, a latch circuit that holds the output of the first gating circuit 216 may be added in the pixel signal processing unit 103. In a case where the output of the latch circuit is input to the second gating circuit 222, the output of the first gating circuit 216 becomes “1” and “1” is set in the first memory circuit 211, the second gating circuit 222 is masked by the latch circuit outputting “0”. This can temporarily deactivate the second memory circuit 217 to prevent double count.

The pulse light source 311 according to the present exemplary embodiment is configured to emit light in an infrared wavelength, and “light emission” in FIG. 10 may be a light emission timing of light in an infrared wavelength that is emitted by the pulse light source 311. In this case, since visible light becomes noise in performing distance measurement, a configuration of attaching an infrared light bandpass filter (visible light cut filter) may be employed. Alternatively, a color filter that passes only infrared light may be arranged over all pixels.

In the present exemplary embodiment, exposure periods to read out two micro-frames that are to be acquired in each pixel are varied in this manner, and a gate shift is performed for each sub-frame period for each pixel. With this configuration, the number of gate shifts required to measure a required number of distance measurement points is reduced as compared with a case of acquiring one micro-frame for each pixel. This shortens the total period of a plurality of sub-frames, that is to say, the length of a frame period (T1 in FIG. 8). It is therefore possible to increase a frame rate without decreasing the number of distance measurement points (distance resolution). As described above, according to the present exemplary embodiment, a photoelectric conversion apparatus with a frame rate increased while ensuring a proper distance resolution is provided.

In the present exemplary embodiment, two micro-frames with different gate pulse timings are acquired in each pixel. However, the number of micro-frames to be acquired in each pixel is not limited to two, and it is sufficient that at least two micro-frames can be acquired. Even in a case where three or more micro-frames with different gate pulse timings are acquired in each pixel, an effect of frame rate increase is obtained. For example, in a case where three micro-frames are acquired in each pixel, a photoelectric conversion apparatus includes a third micro-frame readout unit that acquires third micro-frames, and a third micro-frame addition unit that generates a third sub-frame by synthesizing the third micro-frames. A third exposure period in which a signal included in a third micro-frame is generated is controlled in accordance with a third control signal in such a manner that the above-described first and second exposure periods and the third exposure period differ from each other. As the number of micro-frames with different gate pulse timings that can be acquired in each pixel becomes larger, an effect of frame rate increase becomes larger.

In a second exemplary embodiment, another configuration example of the circuit substrate 21 described in the first exemplary embodiment will be described. The description of the components common to those in the first exemplary embodiment will be sometimes appropriately omitted or simplified.

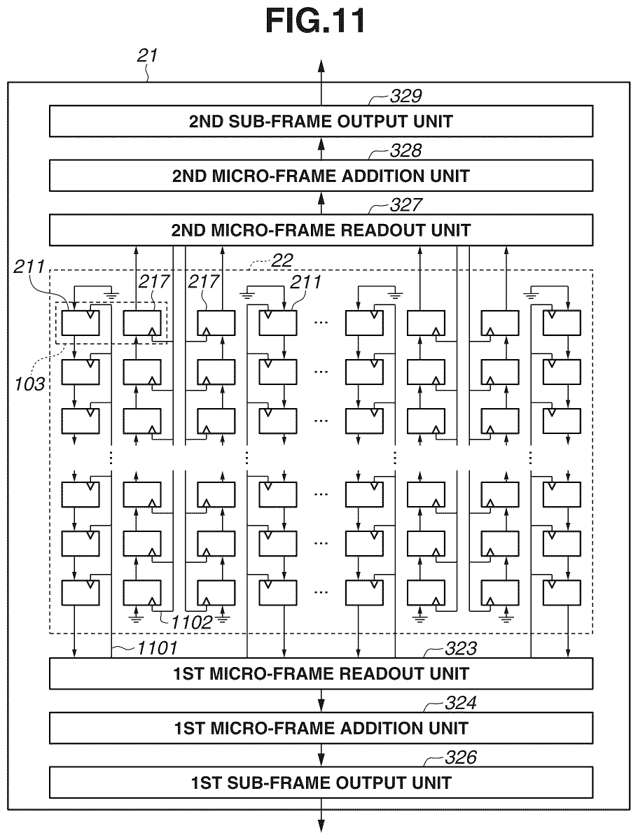

FIG. 11 is a schematic block diagram illustrating a configuration example of a circuit substrate 21. A plurality of pixel signal processing units 103 are arranged on a plurality of rows and a plurality of columns, the first memory circuits 211 and the second memory circuits 217 in the pixel signal processing units 103 are coupled over all the rows, and a shift register in a column direction is formed. A plurality of pixel signal processing units 103 on an even-number column and a plurality of pixel signal processing units 103 on an odd-number column are arranged mirror-symmetrically.

The first micro-frame readout unit 323 supplies a clock 1101 to shift registers on all columns in which the first memory circuits 211 are coupled over all rows, and sequentially reads out data of all columns stored in the first memory circuits 211 from a lower row. The second micro-frame readout unit 327 supplies a clock 1102 to shift registers on all columns in which the second memory circuits 217 are coupled over all rows, and sequentially reads out data of all columns stored in the second memory circuits 217 from an upper row. That is, a readout order of the first micro-frame readout unit 323 and a readout order of the second micro-frame readout unit 327 are opposite to each other in the vertical direction. Reading out a first micro-frame from any side of a pixel array can be rephrased as reading out a second micro-frame from an opposite side thereof.

A one-bit signal included in a first micro-frame read out by the first micro-frame readout unit 323 is held in the memory of the first micro-frame addition unit 324. The first micro-frame addition unit 324 generates a first sub-frame by sequentially adding a value of a micro-frame to a value held in the memory each time a micro-frame is read out.

A one-bit signal included in a second micro-frame read out by the second micro-frame readout unit 327 is held in the memory of the second micro-frame addition unit 328. The second micro-frame addition unit 328 generates a second sub-frame by sequentially adding a value of a micro-frame to a value held in the memory each time a micro-frame is read out.

When storing the micro-frames sequentially read out by the second micro-frame readout unit 327 from an upper low into the memory, the second micro-frame addition unit 328 writes the micro-frames into the memory in an order vertically opposite to that of the first micro-frame addition unit 324. This can generate the second sub-frame with an up-down direction consistent with that of the first sub-frame. More specifically, data of a row (leading row) from which data is first read out by the second micro-frame readout unit 327 is written into the position of a last row in the memory of the second micro-frame addition unit 328.

In a case where the second micro-frame addition unit 328 does not write the micro-frames into the memory in an order vertically opposite to that of the first micro-frame addition unit 324, the first sub-frame and the second sub-frame are held in a vertically-opposite direction. In this case, when sub-frames are read out from a memory, the second sub-frame output unit 329 may read out sub-frames from the memory in an order vertically opposite to that of the first sub-frame output unit 326. By performing such readout, the second sub-frame with an up-down direction consistent with that of the first sub-frame can be output to the second sub-frame group storage unit 333. More specifically, data of a row from which data is first output from the second sub-frame output unit 329 is read out from the position of a last row in the memory of the second micro-frame addition unit 328.

Heretofore, the case where the second micro-frame addition unit 328 writes micro-frames into the memory in a vertically-opposite order, and the case where the second sub-frame output unit 329 reads out micro-frames from the memory in a vertically-opposite order. As other cases, the first micro-frame addition unit 324 may write micro-frames into the memory in a vertically-opposite order, or the first sub-frame output unit 326 may read out micro-frames from the memory in a vertically-opposite order.

In the present exemplary embodiment, the description has been given of the case where a shift register in which the first memory circuits 211 and the second memory circuits 217 are coupled over all rows is formed, and a readout order of rows differs between the first micro-frame readout unit 323 and the second micro-frame readout unit 327. Even in this case, it is possible to output sub-frames with a consistent up-down direction by using the first micro-frame addition unit 324 or the second micro-frame addition unit 328 writing micro-frames into the memory in a vertically-opposite order. t is alternatively possible to output sub-frames with a consistent up-down direction by using the first sub-frame output unit 326 or the second sub-frame output unit 329 reading out micro-frames from the memory in a vertically-opposite order. By uniformizing directions of sub-frames to be output, it is possible to eliminate the use of vertical inversion performed in subsequent processing by the signal processing circuit 33 or an external system (not illustrated).

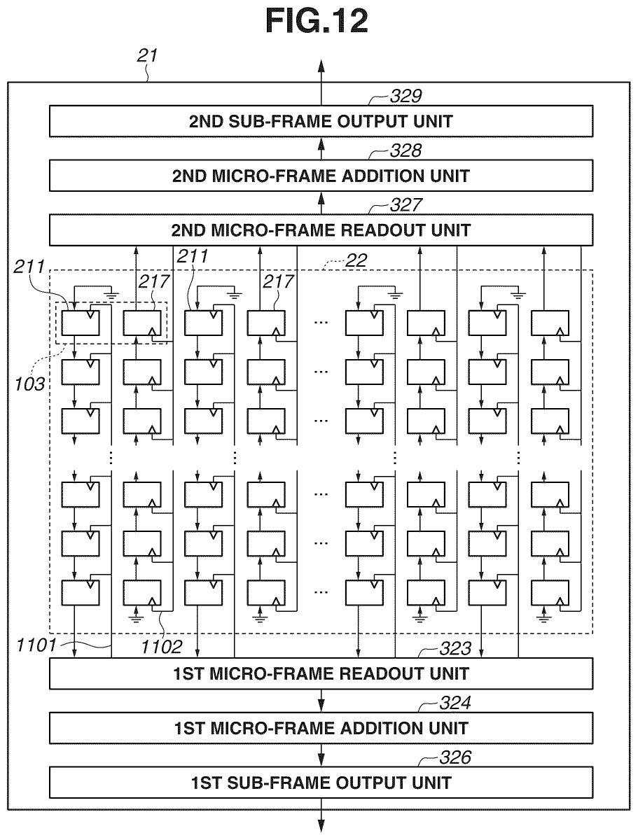

As a modified example of the second exemplary embodiment, FIG. 12 illustrates an example in which a plurality of pixel signal processing units 103 on an even-number column and a plurality of pixel signal processing units 103 on an odd-number column are arranged translational-symmetrically. The description of the components common to those in the second exemplary embodiment will be appropriately omitted.

Even in a third exemplary embodiment, it is possible to output sub-frames with a consistent up-down direction by a corresponding micro-frame addition unit writing micro-frames into the memory in a vertically-opposite order, in a case where a readout order of rows differs between micro-frame readout units. Alternatively, it is possible to output sub-frames with a consistent up-down direction by a corresponding sub-frame output unit reading out micro-frames from the memory in a vertically-opposite order.

In a fourth exemplary embodiment, another example of a gate pulse timing described in the first exemplary embodiment will be described. The description of the components common to those in the first exemplary embodiment will be sometimes appropriately omitted or simplified.

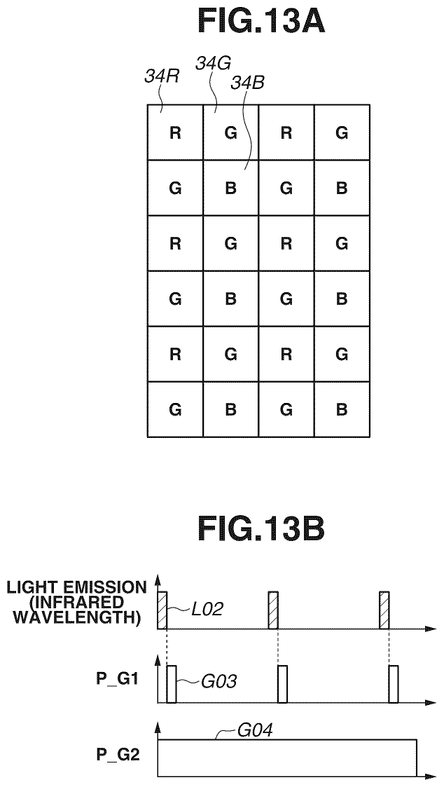

FIG. 13A is a schematic diagram illustrating an array of a pixel group in a pixel array according to the present exemplary embodiment. FIG. 13B is a drive timing diagram illustrating a timing of a gate pulse according to the present exemplary embodiment.

The pixel array according to the present exemplary embodiment includes a first pixel group 34R (“R” in FIG. 13A), a second pixel group 34G (“G” in FIG. 13A), and a third pixel group 34B (“B” in FIG. 13A). The first pixel group 34R, the second pixel group 34G, and the third pixel group 34B are configured to have sensitivity to light rays in mutually-different wavelengths. More specifically, a first color filter that passes red light in a wavelength of 700 nm (nanometers) (first wavelength) is arranged for the first pixel group 34R (first photoelectric conversion element). A second color filter that passes green light in a wavelength of 550 nm (second wavelength) is arranged for the second pixel group 34G (second photoelectric conversion element). A third color filter that passes blue light in a wavelength of 430 nm (third wavelength) is arranged for the third pixel group 34B (third photoelectric conversion element).

The pulse light source 311 according to the present exemplary embodiment is configured to emit light in an infrared wavelength. In FIG. 13B, “light emission (infrared wavelength)” indicates a light emission timing of light in an infrared wavelength that is emitted by the pulse light source 311. “P_G1” and “P_G2” indicate input timings of a plurality of types of gate pulses to be input to the imaging unit 321 from the gate pulse generation unit 322. The input timing indicated by “P_G1” corresponds to the input timing of a control signal to be input to the first gating circuit 216 via the drive line 215 in FIG. 5. The input timing indicated by “P_G2” corresponds to the input timing of a control signal to the second gating circuit 222 via the drive line 221 in FIG. 5.

A gate pulse G03 is input to the first gating circuit 216 connected to the first memory circuit 211 at a timing synchronized with a light emission timing L02 of light in an infrared wavelength. Over a predetermined exposure period in which image capturing is performed, a gate pulse G04 is input to the second gating circuit 222 connected to the second memory circuit 217.

The second memory circuit 217 can thereby obtain signals including information regarding the respective colors of red, green, and blue. It is accordingly possible to generate a color image using these signals. The three colors corresponding to red, green, and blue are examples, and if acquired signals include a plurality of pieces of color information of a visible region, a color image can be generated. Similarly to the first exemplary embodiment, the first memory circuit 211 can acquire distance information by the gate pulse G03 being input at a timing synchronized with light emission.

It is generally known that the first color filter that passes red light in the wavelength of 700 nm (first wavelength), the second color filter that passes green light in the wavelength of 550 nm (second wavelength), and the third color filter that passes blue light in the wavelength of 430 nm (third wavelength) also pass light in an infrared wavelength (fourth wavelength). The first pixel group 34R, the second pixel group 34G, and the third pixel group 34B also have sensitivity to light in an infrared wavelength, accordingly. In the case of emitting light in an infrared wavelength, the pulse light source 311 can thus acquire a signal for distance measurement. At this time, an infrared light cut filter that cuts light in an infrared wavelength is attached to a general photoelectric conversion apparatus that performs only image capturing, but an infrared light cut filter is not attached in the present exemplary embodiment. Moreover, in a case where a wavelength used in distance measurement is an infrared wavelength of 1000 nm, a filter that cuts the range from the wavelength of 700 nm as the first wavelength to the infrared wavelength of 1000 nm is attached.

According to the configuration of the present exemplary embodiment as described above, it is possible to acquire a signal for distance measurement and a signal for color image generation within the same sub-frame period. Accordingly, a photoelectric conversion apparatus that can acquire a color image and a distance image while maintaining a distance resolution and a frame rate is provided.

In a fifth exemplary embodiment, an example of a configuration in which a recharge pulse for resetting a photoelectric conversion element can be further input to a pixel circuit will be described as a modified example of the fourth exemplary embodiment. The description of the components common to those in the first to fourth exemplary embodiments will be sometimes appropriately omitted or simplified.

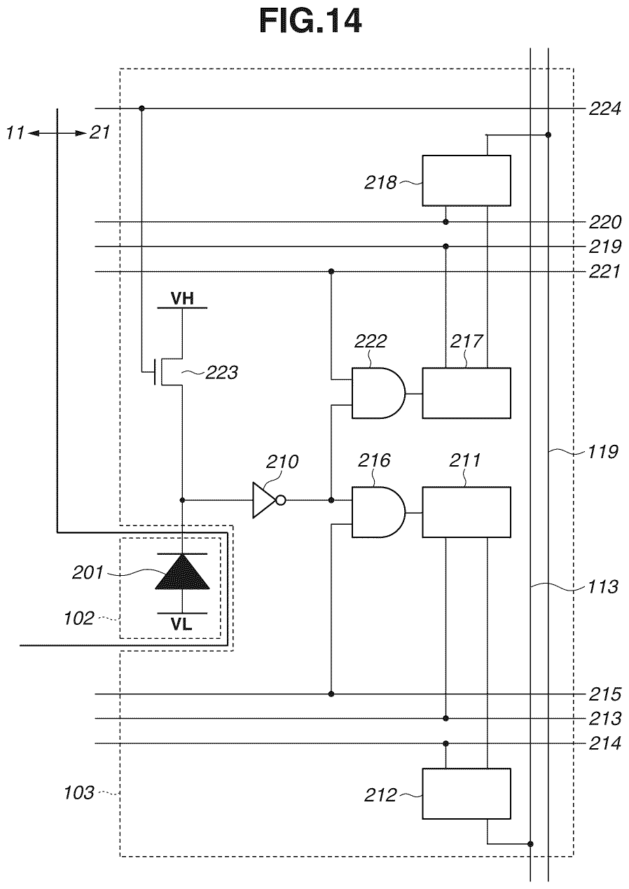

FIG. 14 is a schematic block diagram of a pixel according to the present exemplary embodiment. In FIG. 14, a transistor 223 is arranged as a specific example of the quench element 202 in FIG. 5. The transistor 223 is an N-channel metal oxide semiconductor (NMOS) transistor. The source of the transistor 223 is connected to a connection node between the APD 201 and the input terminal of the waveform shaping unit 210. The voltage VH is supplied to the drain of the transistor 223. A recharge pulse is input to the gate of the transistor 223 via the drive line 224 from the first vertical scanning circuit 110 to the second vertical scanning circuit 116. As described above, if avalanche multiplication occurs in the APD 201 and an avalanche current flows, a voltage supplied to the APD 201 drops (quench operation). If a high-level recharge pulse is input to the transistor 223, the transistor 223 is turned on, a cathode potential of the APD 201 is reset, and a voltage that enables avalanche multiplication is applied to the APD 201. This operation is called a recharge operation. The transistor 223 may be a P-channel metal oxide semiconductor (PMOS) transistor. In this case, the polarity of a recharge pulse to be input to the transistor 223 is reversed.

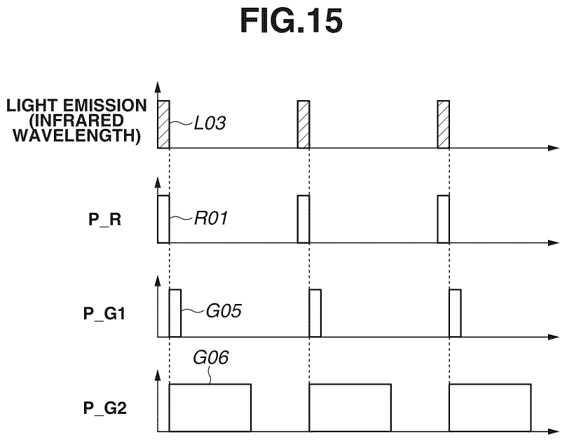

FIG. 15 is a drive timing diagram illustrating timings of a gate pulse and a recharge pulse according to the present exemplary embodiment. The configuration of pixel groups in the pixel array according to the present exemplary embodiment is similar to that in the fourth exemplary embodiment. Similarly to the fourth exemplary embodiment, the pulse light source 311 according to the present exemplary embodiment is also configured to emit light in an infrared wavelength. “P_R” indicates a recharge pulse.

A recharge pulse synchronized with a light emission timing L03 is regarded as a recharge pulse R01.

The recharge pulse R01 becomes the high level after the lapse of a predetermined time from light emission by the pulse light source 311.

After the recharge pulse R01 has fallen down, a gate pulse G05 input to the first gating circuit 216 connected to the first memory circuit 211 becomes the high level. In addition, a gate pulse G06 input to the second gating circuit 222 connected to the second memory circuit 217 becomes the high level. In the timing diagram illustrated in FIG. 15, a period in which the gate pulse G06 is at the high level is longer than a period in which the gate pulse G05 is at the high level.

In the second memory circuit 217, a period from the rising of the recharge pulse R01 to the falling of the gate pulse G06 is a photon detection period for the capturing of a color image. That is, in the configuration according to the present exemplary embodiment, it is possible to control a charge accumulation time in the capturing of a color image by appropriately setting the timings of the recharge pulse R01 and the gate pulse G06. In the configuration according to the third exemplary embodiment, the gate pulse G04 for the capturing of a color image is maintained at the high level, and thus image blurring or signal mixing from a different subject sometimes occurs. Nevertheless, in the configuration according to the present exemplary embodiment, it is possible to reduce influence attributed to these factors by appropriately setting a charge accumulation time in the capturing of a color image. According to the present exemplary embodiment, it is possible to further improve image quality in addition to the effect similar to that in the fourth exemplary embodiment.

As an electronic device to which the photoelectric conversion apparatus 100 is applied, a digital camera is given. It is known that a digital camera has an automatic exposure (AE) function of automatically controlling exposure in such a manner that a captured image becomes a moderately bright image irrespective of the brightness of a subject. In a sixth exemplary embodiment, the description will be given of an example of a configuration in which the AE function can further be executed during the image capturing of a color image in the fifth exemplary embodiment. The description of the components common to those in the first to fifth exemplary embodiments will be sometimes appropriately omitted or simplified.

In executing the AE function, the signal processing circuit 33 acquires, from the light receiving apparatus 32, brightness information of a subject such as a value of integral of pixel values. The signal processing circuit 33 adjusts a gate pulse width for the capturing of a color image by controlling a gate pulse generation unit based on the acquired brightness information of the subject.

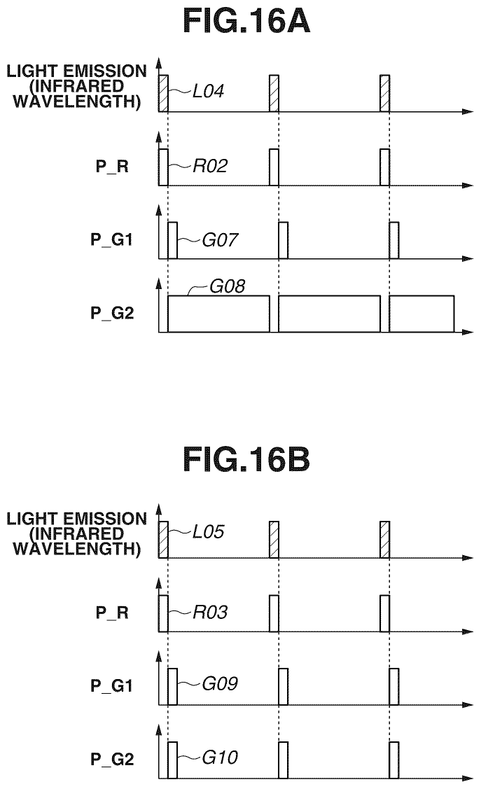

FIG. 16A is a drive timing diagram illustrating timings of a gate pulse and a recharge pulse according to the present exemplary embodiment in a low illuminance state. FIG. 16B is a drive timing diagram illustrating timings of a gate pulse and a recharge pulse according to the present exemplary embodiment in a high illuminance state. The configuration of pixel groups in the pixel array according to the present exemplary embodiment is similar to that in the fourth exemplary embodiment. Similarly to the fourth exemplary embodiment, the pulse light source 311 according to the present exemplary embodiment is also configured to emit light in an infrared wavelength.

In a low illuminance state illustrated in FIG. 16A, a recharge pulse synchronized with a light emission timing L04 is regarded as a recharge pulse R02. The recharge pulse R02 becomes the high level after the lapse of a predetermined time from light emission by the pulse light source 311.

After the recharge pulse R02 has fallen down, a gate pulse G07 input to the first gating circuit 216 connected to the first memory circuit 211 becomes the high level. In addition, a gate pulse G08 input to the second gating circuit 222 connected to the second memory circuit 217 becomes the high level.

In the second memory circuit 217, a period from the falling of the recharge pulse R02 to the falling of the gate pulse G08 is a photon detection period for the capturing of a color image. In the low illuminance state, the AE function is implemented by performing adjustment in such a manner that a high-level period of the gate pulse G08 becomes long and a charge accumulation time in the capturing of a color image becomes long.

In the high illuminance state illustrated in FIG. 16B, a recharge pulse synchronized with a light emission timing L05 is regarded as a recharge pulse R03. The recharge pulse R03 becomes the high level after the lapse of a predetermined time from light emission by the pulse light source 311.

After the recharge pulse R03 has fallen down, a gate pulse G09 to be input to the first gating circuit 216 connected to the first memory circuit 211 becomes the high level. In addition, a gate pulse G10 to be input to the second gating circuit 222 connected to the second memory circuit 217 becomes the high level.

In the second memory circuit 217, a period from the falling of the recharge pulse R03 to the falling of the gate pulse G10 is a photon detection period for the capturing of a color image. In the high illuminance state, the AE function is implemented by performing adjustment in such a manner that a high-level period of the gate pulse G10 becomes short and a charge accumulation time in the capturing of a color image becomes short.

As described above, a high-level period of a gate pulse to be used for distance measurement can be set to a fixed width, and a high-level period of a gate pulse to be used for image capturing can be controlled to be variable by AE control. According to the present exemplary embodiment, exposure adjustment is thus automatically performed in addition to the effect similar to the fifth exemplary embodiment, and a captured image becomes a moderately-bright image irrespective of the brightness of a subject.

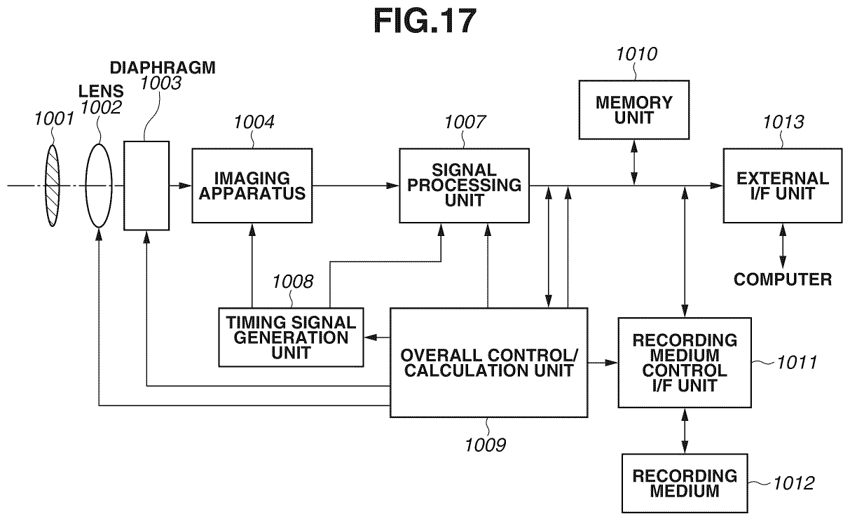

A photoelectric conversion system according to a seventh exemplary embodiment will be described with reference to FIG. 17. FIG. 17 is a block diagram illustrating a schematic configuration of a photoelectric conversion system according to the present exemplary embodiment.

The photoelectric conversion apparatuses (imaging apparatuses) described in the above-described first to sixth exemplary embodiments can be applied to various photoelectric conversion systems. Examples of photoelectric conversion systems to which the photoelectric conversion apparatus can be applied include a digital still camera, a digital camcorder, a monitoring camera, a copier, a facsimile, a mobile phone, an in-vehicle camera, and an observation satellite. A camera module including an optical system such as a lens, and an imaging apparatus is also included in the photoelectric conversion systems. As an example of these photoelectric conversion systems, FIG. 17 exemplarily illustrates a block diagram of a digital still camera.

The photoelectric conversion system exemplified in FIG. 17 includes an imaging apparatus 1004 serving as an example of the photoelectric conversion apparatus, and a lens 1002 that forms an optical image of a subject on the imaging apparatus 1004. The photoelectric conversion system also includes a diaphragm 1003 for varying an amount of light passing through the lens 1002, and a barrier 1001 for protecting the lens 1002. The lens 1002 and the diaphragm 1003 serve as an optical system that condenses light onto the imaging apparatus 1004. The imaging apparatus 1004 is the photoelectric conversion apparatus (imaging apparatus) according to any of the above-described exemplary embodiments, and converts an optical image formed by the lens 1002 into an electric signal.

The photoelectric conversion system further includes a signal processing unit 1007 serving as an image generation unit that generates an image by processing an output signal output by the imaging apparatus 1004. The signal processing unit 1007 performs an operation of outputting image data after performing various types of correction and compression as necessary. The signal processing unit 1007 may be formed on a semiconductor substrate on which the imaging apparatus 1004 is provided or may be formed on a semiconductor substrate different from that of the imaging apparatus 1004. The imaging apparatus 1004 and the signal processing unit 1007 may also be formed on the same semiconductor substrate.

The photoelectric conversion system further includes a memory unit 1010 for temporarily storing image data, and an external interface unit (external I/F unit) 1013 for communicating with an external computer. The photoelectric conversion system further includes a recording medium 1012, such as a semiconductor memory, for recording or reading out captured image data, and a recording medium control interface unit (recording medium control I/F unit) 1011 for performing recording onto or readout from the recording medium 1012. The recording medium 1012 may be built into the photoelectric conversion system or may be detachably attached to the photoelectric conversion system.

The photoelectric conversion system further includes an overall control/calculation unit 1009 that controls various types of calculation and the entire digital still camera, and a timing signal generation unit 1008 that outputs various timing signals to the imaging apparatus 1004 and the signal processing unit 1007. The timing signals may be input from the outside. The photoelectric conversion system is only required to include at least the imaging apparatus 1004 and the signal processing unit 1007 that processes an output signal output from the imaging apparatus 1004.

The imaging apparatus 1004 outputs an imaging signal to the signal processing unit 1007. The signal processing unit 1007 performs predetermined signal processing on the imaging signal output from the imaging apparatus 1004 to output image data. The signal processing unit 1007 generates an image using the imaging signal.

In this manner, the present exemplary embodiment can realize a photoelectric conversion system to which the photoelectric conversion apparatus (imaging apparatus) according to any of the above-described exemplary embodiments is applied.

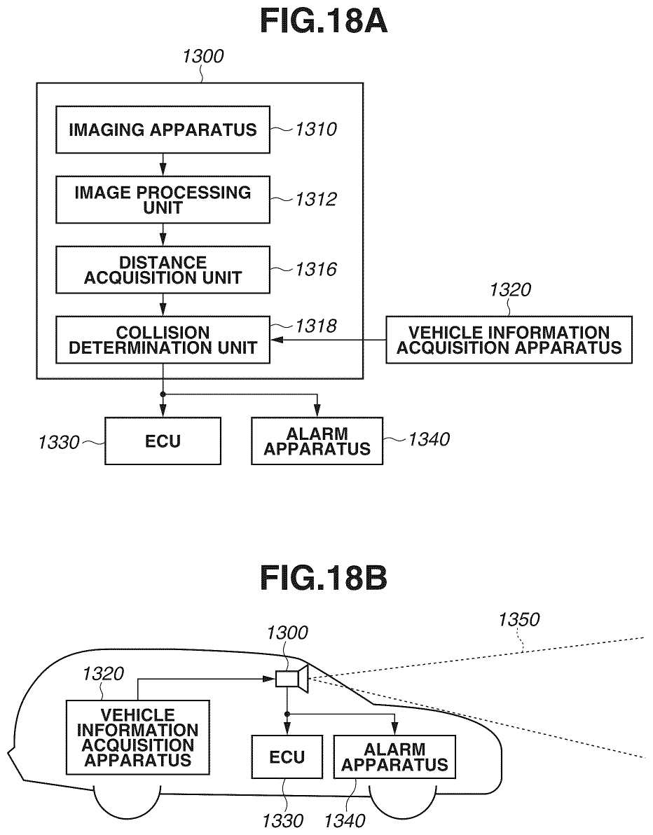

A photoelectric conversion system and a moving body according to an eighth exemplary embodiment will be described with reference to FIGS. 18A and 18B. FIGS. 18A and 18B are diagrams illustrating configurations of the photoelectric conversion system and the moving body according to the present exemplary embodiment.

FIG. 18A illustrates an example of a photoelectric conversion system related to an in-vehicle camera. A photoelectric conversion system 1300 includes an imaging apparatus 1310. The imaging apparatus 1310 is the photoelectric conversion apparatus (imaging apparatus) according to any of the above-described exemplary embodiments. The photoelectric conversion system 1300 includes an image processing unit 1312 that performs image processing on a plurality of pieces of image data acquired by the imaging apparatus 1310. The photoelectric conversion system 1300 further includes a distance acquisition unit 1316 that calculates a distance to a target object, and a collision determination unit 1318 that determines whether collision is likely to occur, based on the calculated distance. In this example, the distance acquisition unit 1316 may acquire distance information regarding a distance to a time of flight (ToF) target object or may acquire distance information using parallax information. More specifically, the distance information is information regarding a parallax, a defocus amount, and a distance to a target object. The collision determination unit 1318 may determine collision likelihood using any of these pieces of distance information. The distance information acquisition unit may be implemented by dedicatedly-designed hardware or may be implemented by a software module. Alternatively, the distance information acquisition unit may be implemented by a field programmable gate array (FPGA) or an application specific integrated circuit (ASIC) or may be implemented by the combination of these.

The photoelectric conversion system 1300 is connected with a vehicle information acquisition apparatus 1320, and can acquire vehicle information, such as a vehicle speed, a yaw rate, or a rudder angle. In addition, an electronic control unit (ECU) 1330 is connected to the photoelectric conversion system 1300. The ECU 1330 serves as a control apparatus that outputs a control signal for generating braking force, to a vehicle based on a determination result obtained by the collision determination unit 1318. The photoelectric conversion system 1300 is also connected with an alarm apparatus 1340 that raises an alarm to a driver based on a determination result obtained by the collision determination unit 1318. For example, in a case where the determination result obtained by the collision determination unit 1318 indicates high collision likelihood, the ECU 1330 performs vehicle control for avoiding collision or reducing damages by braking, releasing an accelerator, or suppressing engine output. The alarm apparatus 1340 issues an alarm to a user by sounding an alarm such as sound, displaying warning information on a display unit screen of a car navigation system, or vibrating a seatbelt or a steering wheel.

In the present exemplary embodiment, the photoelectric conversion system 1300 captures an image of the periphery of the vehicle, such as the front side or the rear side. FIG. 18B illustrates the photoelectric conversion system 1300 for capturing an image of a vehicle front side (imaging range 1350). The vehicle information acquisition apparatus 1320 issues an instruction to the photoelectric conversion system 1300 or the imaging apparatus 1310. With this configuration, the accuracy of distance measurement can be further improved.

The above description has been given of an example in which control is performed in such a manner as not to collide with another vehicle. The photoelectric conversion system can also be applied to the control for performing automatic driving by following another vehicle, or the control for performing automatic driving in such a manner as not to deviate from a lane. Furthermore, the photoelectric conversion system can be applied to a moving body (moving apparatus), such as a vessel, an aircraft, or an industrial robot, for example, aside from a vehicle, such as an automobile. This moving body includes either one or both of a drive force generation unit that generates drive force to be mainly used for the movement of the moving body, and a rotator to be mainly used for the movement of the moving body. The drive force generation unit can be an engine, a motor, or the like. The rotator can be a tire, a wheel, a screw of a ship, a propeller of a flight vehicle, or the like. Moreover, the photoelectric conversion system can be applied to a device that extensively uses object recognition, such as an intelligent transport system (ITS), in addition to a moving body.

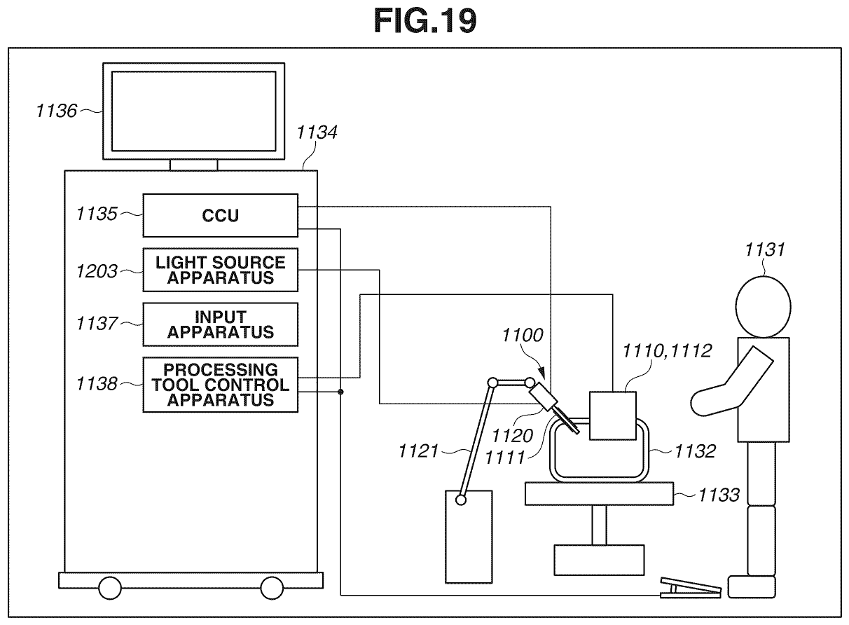

A photoelectric conversion system according to a ninth exemplary embodiment will be described with reference to FIG. 19. FIG. 19 is a diagram illustrating an example of a schematic configuration of an endoscopic operation system serving as a photoelectric conversion system of the present exemplary embodiment.

FIG. 19 illustrates a state in which an operator (doctor) 1131 is performing an operation on a patient 1132 lying on a patient bed 1133, using an endoscopic operation system. As illustrated in FIG. 19, the endoscopic operation system includes an endoscope 1100, a surgical tool 1110, and a cart 1134 equipped with various apparatuses for an endoscopic operation.

The endoscope 1100 includes a lens barrel 1111 having a region to be inserted into a body cavity of the patient 1132 by a predetermined length from a distal end, and a camera head 1120 connected to a proximal end of the lens barrel 1111. In the example illustrated in FIG. 19, the endoscope 1100 formed as a so-called rigid scope including the rigid lens barrel 1111 is illustrated, but the endoscope 1100 may be formed as a flexible scope including a so-called flexible lens barrel.

At the distal end of the lens barrel 1111, an opening portion into which an objective lens is fitted is provided. A light source apparatus 1203 is connected to the endoscope 1100, and light generated by the light source apparatus 1203 is guided to the distal end of the lens barrel 1111 by a light guide extended inside the lens barrel 1111 and emitted onto an observation target in the body cavity of the patient 1132 via the objective lens. The endoscope 1100 may be a direct view endoscope or may be an oblique view endoscope or a lateral view endoscope.

An optical system and a photoelectric conversion apparatus are provided inside the camera head 1120. Reflected light (observation light) from an observation target is condensed by the optical system to the photoelectric conversion apparatus. The observation light is photoelectrically converted by the photoelectric conversion apparatus, and an electric signal corresponding to the observation light (i.e., image signal corresponding to an observed image) is generated. The photoelectric conversion apparatus (imaging apparatus) described in each of the above exemplary embodiments can be used as the photoelectric conversion apparatus. The image signal is transmitted to a camera control unit (CCU) 1135 as RAW data.

The CCU 1135 includes a central processing unit (CPU) or a graphics processing unit (GPU), and comprehensively controls operations of the endoscope 1100 and a display device 1136. The CCU 1135 also receives an image signal from the camera head 1120 and performs various types of image processing for displaying an image that is based on the image signal, such as development processing (demosaic processing), on the image signal.

Based on the control from the CCU 1135, the display device 1136 displays an image that is based on an image signal on which image processing has been performed by the CCU 1135.

The light source apparatus 1203 includes a light source, such as a light emitting diode (LED), and supplies irradiating light for capturing an image of an operative site, to the endoscope 1100.

An input apparatus 1137 is an input interface for the endoscopic operation system. A user can input various types of information and instructions to the endoscopic operation system via the input apparatus 1137.

A processing tool control apparatus 1138 controls the driving of an energy processing tool 1112 for cauterizing or cutting a tissue, or sealing a blood vessel.

The light source apparatus 1203 that supplies irradiating light for capturing an image of an operative site, to the endoscope 1100 can include, for example, an LED, a laser light source, or a white light source including a combination of these. In a case where a white light source includes a combination of RGB laser light sources, output intensity and an output timing of each color (each wavelength) can be controlled highly accurately, and thus white balance of a captured image can be adjusted in the light source apparatus 1203. In this case, an image corresponding to each of RGB can be captured in a time division manner by emitting laser light from each RGB laser light source onto an observation target in a time division manner and controlling the driving of an image sensor of the camera head 1120 in synchronization with the emission timing. According to the method, a color image can be obtained without providing a color filter in the image sensor.

The driving of the light source apparatus 1203 may be controlled in such a manner as to change the intensity of light to be output every predetermined time. It is possible to generate a high dynamic range image without so-called blocked up shadows and clipped whites by acquiring images in a time division manner by controlling the driving of the image sensor of the camera head 1120 in synchronization with the change timing of the light intensity and combining the images.

The light source apparatus 1203 may be configured to supply light in a predetermined wavelength band adapted to special light observation. The special light observation utilizes, for example, wavelength dependency of light absorption in body tissues. Specifically, the special light observation captures an image of a predetermined tissue, such as a blood vessel of a superficial portion of a mucous membrane, with high contrast by emitting light in a narrower band as compared with irradiating light (i.e., white light) in normal observation.

Alternatively, the special light observation may perform fluorescent observation of obtaining an image by fluorescence generated by emitting excitation light. In the fluorescent observation, fluorescence from a body tissue can be observed by emitting excitation light onto the body tissue, or a fluorescent image can be obtained by locally injecting reagent such as indocyanine green (ICG) into a body tissue and emitting excitation light suitable for a fluorescence wavelength of the reagent onto the body tissue. The light source apparatus 1203 can supply narrow-band light and/or excitation light adapted to such special light observation.

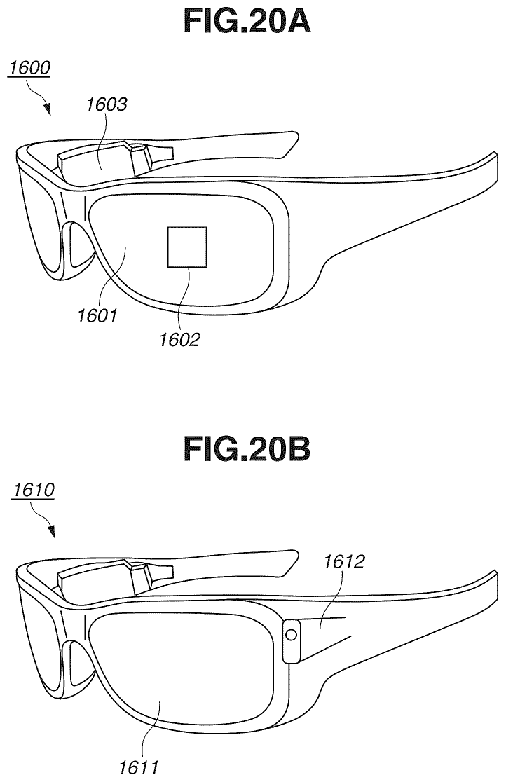

A photoelectric conversion system according to a tenth exemplary embodiment will be described with reference to FIGS. 20A and 20B. FIG. 20A is a diagram illustrating an example of a configuration of eyeglasses 1600 (smart glasses) serving as a photoelectric conversion system. The eyeglasses 1600 include a photoelectric conversion apparatus 1602. The photoelectric conversion apparatus 1602 is the photoelectric conversion apparatus (imaging apparatus) described in each of the above-described exemplary embodiments. On the back surface side of a lens 1601, a display device including a light emission device, such as an organic light emitting diode (OLED) or an LED, may be provided. The number of photoelectric conversion apparatuses 1602 may be one or plural. A plurality of types of photoelectric conversion apparatuses may be used in combination. An arrangement position of the photoelectric conversion apparatus 1602 is not limited to the position illustrated in FIG. 20A.

The eyeglasses 1600 further include a control apparatus 1603. The control apparatus 1603 functions as a power source that supplies power to the photoelectric conversion apparatus 1602 and the above-described display device. The control apparatus 1603 controls operations of the photoelectric conversion apparatus 1602 and the display device. In the lens 1601, an optical system for condensing light to the photoelectric conversion apparatus 1602 is formed.

FIG. 20B illustrates eyeglasses 1610 (smart glasses) according to one application example. The eyeglasses 1610 include a control apparatus 1612, and the control apparatus 1612 is equipped with a photoelectric conversion apparatus equivalent to the photoelectric conversion apparatus 1602, and a display device. In a lens 1611, an optical system for projecting light emitted from the photoelectric conversion apparatus and the display device in the control apparatus 1612 is formed, and an image is projected onto the lens 1611. The control apparatus 1612 functions as a power source that supplies power to the photoelectric conversion apparatus and the display device, and controls operations of the photoelectric conversion apparatus and the display device. The control apparatus may include a visual line detection unit that detects a visual line of a wearer. Infrared light may be used for the detection of a visual line. An infrared light emission unit emits infrared light onto an eyeball of a user gazing at a displayed image. An imaging unit including a light receiving element detects reflected light of the emitted infrared light that has been reflected from the eyeball. A captured image of the eyeball is thereby obtained. By including a reduction unit for reducing light from the infrared light emission unit to a display unit in a planar view, a decline in image quality is suppressed.

From a captured image of an eyeball obtained by image capturing using infrared light, a visual line of a user with respect to a displayed image is detected. Any known method can be applied to visual line detection that uses a captured image of an eyeball. As an example, a visual line detection method that is based on a Purkinje image obtained by reflection of irradiating light on a cornea can be used.

More specifically, visual line detection processing that is based on the pupil center corneal reflection is performed. By calculating an eye vector representing the direction (rotational angle) of an eyeball based on an image of a pupil and a Purkinje image that are included in a captured image of the eyeball, a visual line of a user is detected by using the pupil center corneal reflection.

The display device according to the present exemplary embodiment includes the photoelectric conversion apparatus including a light receiving element, and a displayed image of the display device may be controlled based on visual line information of the user from the photoelectric conversion apparatus.

Specifically, the display device determines a first viewing area gazed by the user, and a second viewing area other than the first viewing area based on the visual line information. The first viewing area and the second viewing area may be determined by a control apparatus of the display device, or the first viewing area and the second viewing area determined by an external control apparatus may be received. In a display region of the display device, a display resolution of the first viewing area may be controlled to be higher than a display resolution of the second viewing area. In other word, a resolution of the second viewing area may be made lower than a resolution of the first viewing area.

The display region may include a first display region and a second display region different from the first display region. Based on the visual line information, a region with high priority may be determined from the first display region and the second display region. The first display region and the second display region may be determined by a control apparatus of the display device. Alternatively, the first display region and the second display region determined by an external control apparatus may be received. A resolution of a region with high priority may be controlled to be higher than a resolution of a region other than the region with high priority. In other words, a resolution of a region with relatively-low priority may be set to a low resolution.

For determining the first viewing area and the region with high priority, artificial intelligence (AI) may be used. The AI may be a model configured to estimate an angle of a visual line, and a distance to a target in line of sight, from an image of an eyeball using teaching data including an image of the eyeball, and a direction in which the eyeball actually gives a gaze. AI programs may be included in the display device or in the photoelectric conversion apparatus or may be included in an external apparatus. In a case where an external apparatus includes an AI program, the AI program is transmitted to the display device via communication.

In a case where display control is performed based on visual line detection, the aspect of the embodiments can be applied to smart glasses further including a photoelectric conversion apparatus that captures an image of the outside. The smart glasses can display external information obtained by image capturing in real time.

The above-described photoelectric conversion apparatus and photoelectric conversion system may be applied to, for example, an electronic device, such as a so-called smartphone and a tablet.

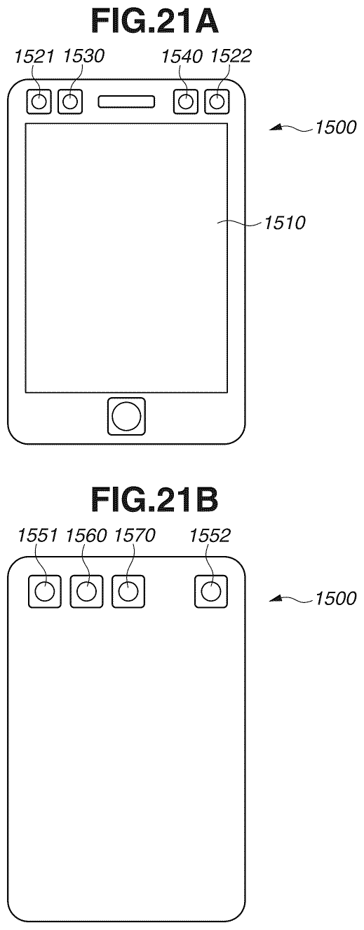

FIGS. 21A and 21B are diagrams illustrating an example of an electronic device 1500 on which a photoelectric conversion apparatus is mounted. FIG. 21A illustrates a front surface side of the electronic device 1500, and FIG. 21B illustrates a rear surface side of the electronic device 1500.

As illustrated in FIG. 21A, a display 1510 for displaying an image is arranged at the center on the front surface of the electronic device 1500. Along an upper side of the front surface of the electronic device 1500, front cameras 1521 and 1522 in which photoelectric conversion apparatuses are used, an IR light source 1530 that emits infrared light and a visible light source 1540 that emits visible light are arranged.

As illustrated in FIG. 21B, rear cameras 1551 and 1552 in which photoelectric conversion apparatuses are used, an IR light source 1560 that emits infrared light, and a visible light source 1570 that emits visible light are arranged along an upper side of the rear surface of the electronic device 1500.

In the electronic device 1500 having such a configuration, for example, it is possible to capture a higher quality image by applying the above-described photoelectric conversion apparatus. Aside from these, the photoelectric conversion apparatus can be applied to an electronic device, such as an infrared sensor, a distance measurement sensor that uses an active infrared light source, a security camera, or a personal or biometric authentication camera. The accuracy and performance of these electronic devices can thereby be enhanced.

In this specification, the wordings such as “A or B”, “at least one of A and B”, “at least one of A or/and B”, and “one or more of A or/and B” can include all possible combinations of listed items, unless otherwise explicitly defined. That is, the above-described wordings are interpreted as disclosing all cases of a case where at least one A is included, a case where at least one B is included, and a case where both of at least one A and at least one B are included. The same applies to the combination of three or more components.

The exemplary embodiments described above can be appropriately changed without departing from the technical idea. The disclosure in this specification is not limited to matters described in this specification and includes all matters that can be identified from this specification and the drawings accompanying this specification. The disclosure in this specification includes a complementary set of individual concepts described in this specification. More specifically, if “A is larger than B” is described in this specification, for example, this specification is assumed to disclose that “B is not larger than A” even if the description “B is not larger than A” is omitted. This is because, in a case where “A is larger than B” is described, a case where “B is not larger than A” is assumed to be considered.

According to the aspect of the embodiments, it is possible to increase a frame rate while ensuring a distance resolution.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-139546, filed August 30, 2023, which is hereby incorporated by reference herein in its entirety.

What is claimed is:

1. An apparatus comprising:
a pixel array in which a plurality of pixels including a photoelectric conversion element is arranged in an array;
a first readout unit configured to acquire a first micro-frame based on incident light on each of the plurality of pixels;
a second readout unit configured to acquire a second micro-frame based on incident light on each of the plurality of pixels;
a first addition unit configured to generate a first sub-frame by synthesizing the first micro-frame;
a second addition unit configured to generate a second sub-frame by synthesizing the second micro-frame;
a first readout unit configured to read out the first micro-frame from any side of the pixel array; and
a second readout unit configured to read out the second micro-frame from an opposite side of the side,
wherein a first exposure period in which generation of a signal included in the first micro-frame is performed is controlled in accordance with a first control signal,
wherein a second exposure period in which generation of a signal included in the second micro-frame is performed is controlled in accordance with a second control signal, and
wherein, in an acquisition period of one micro-frame, the first exposure period and the second exposure period differ from each other.

2. The apparatus according to claim 1, wherein the first sub-frame is a multibit signal.

3. The apparatus according to claim 2, wherein the first micro-frame is a one-bit signal.

4. The apparatus according to claim 1,
wherein the first readout unit reads out a signal that is based on the incident light, in order from a pixel arranged on a leading row to a last row of the pixel array, and
wherein the second readout unit reads out a signal that is based on the incident light, in order from a pixel arranged on a leading row to a last row of the pixel array, in an order opposite to an order of readout executed by the first readout unit.

5. The apparatus according to claim 1, wherein, in a case where the first readout unit reads out a signal that is based on the incident light, in order from a pixel arranged on a last row of the pixel array, the first addition unit generates a vertically-inverted sub-frame.

6. The apparatus according to claim 1, wherein, in a case where the second readout unit reads out a signal that is based on the incident light, in order from a pixel arranged on a last row of the pixel array, the second addition unit generates a vertically-inverted sub-frame.

7. The apparatus according to claim 1, wherein the first micro-frame is used for distance measurement, and the second micro-frame is used for image capturing.

8. The apparatus according to claim 7, wherein the first exposure period is constant and the second exposure period is controlled to be variable by automatic exposure control.

9. The apparatus according to claim 7,
wherein the pixel array includes a first photoelectric conversion element having sensitivity to a first wavelength, a second photoelectric conversion element having sensitivity to a second wavelength, and a third photoelectric conversion element having sensitivity to a third wavelength, and
wherein the first wavelength or the third wavelength is a wavelength in a visible region.

10. The apparatus according to claim 1, wherein the plurality of pixels includes a photoelectric conversion element having sensitivity to a fourth wavelength that is an infrared wavelength.

11. The apparatus according to claim 1,
wherein the first exposure period starts at a time at which a first time period elapses from a light emission timing of a light source for emitting light to a target object, and
wherein the second exposure period starts at a time at which a second time period different from the first time period elapses from the light emission timing.

12. The apparatus according to claim 1,
wherein the photoelectric conversion element includes a photodiode, and
wherein the signal indicates existence or non-existence of photon incidence on the photodiode within a period in which the one micro-frame is acquired.

13. The apparatus according to claim 12,
wherein an input terminal of a first gating circuit to which a signal included in the first micro-frame is input, and an input terminal of a second gating circuit to which a signal included in the second micro-frame is input are connected in parallel to an output terminal of the photodiode,
wherein the first gating circuit is connected to a first counter circuit configured to count a signal included in the first micro-frame, and
wherein the second gating circuit is connected to a second counter circuit configured to count a signal included in the second micro-frame.

14. The apparatus according to claim 13, wherein the photodiode is an avalanche photodiode.

15. The apparatus according to claim 2,
wherein the first addition unit generates the multibit signal by adding a value of the signal each time the first micro-frame is acquired.

16. The apparatus according to claim 1, further comprising:
a third readout unit configured to acquire a third micro-frame based on incident light on each of the plurality of pixels; and
a third addition unit configured to generate a third sub-frame by synthesizing the third micro-frame,
wherein a third exposure period in which generation of a signal included in the third micro-frame is performed is controlled in accordance with a third control signal, and
wherein, in an acquisition period of one micro-frame, the first exposure period, the second exposure period, and the third exposure period differ from each other.

17. An apparatus comprising:
a pixel array in which a plurality of pixels including a photodiode is arranged in an array;
an input terminal of a first gating circuit to which a signal included in a first micro-frame is input, and an input terminal of a second gating circuit to which a signal included in a second micro-frame is input, which are connected in parallel to an output terminal of the photodiode;
a first readout unit configured to acquire the first micro-frame that is connected to an output terminal of the first gating circuit via a first counter circuit configured to count a signal included in the first micro-frame;
a second readout unit configured to acquire the second micro-frame that is connected to an output terminal of the second gating circuit via a second counter circuit configured to count a signal included in the second micro-frame;
a first addition unit configured to generate a first sub-frame by synthesizing the first micro-frame; and
a second addition unit configured to generate a second sub-frame by synthesizing the second micro-frame.

18. The apparatus according to claim 17, wherein the photodiode is an avalanche photodiode.

19. A system comprising:
the apparatus according to claim 1; and
a processing unit configured to generate an image by using a signal output by the apparatus.

20. A moving body comprising:
the apparatus according to claim 1; and
a control unit configured to control a movement of the moving body by using a signal output by the apparatus.
